(19) United States
(12) Patent Application Publication
(10) Pub. No.: US 2017/0330295 A1
(43) Pub. Date: Nov. 16, 2017

(54) HOUSEHOLD ANIMAL TRANSPORT CLEARINGHOUSE PLATFORM AND METHOD OF USE THEREOF

(71) Applicant: PawsGlobal, Inc., Boston, MA (US)

(72) Inventors: Marcia Engel Alden, Boston, MA (US); Rhett G. Alden, Boston, MA (US)

(73) Assignee: PawsGlobal, Inc., Boston, MA (US)

(21) Appl. No.: 15/592,847

(22) Filed: May 11, 2017

Related U.S. Application Data
(60) Provisional application No. 62/335,086, filed on May 12, 2016.

(51) Int. Cl. G06Q 50/14; G06F 19/00; G06Q 10/02; G06Q 30/00

(52) U.S. Cl. CPC G06Q 50/14; G06Q 30/016; G06F 19/3418; G06Q 10/025

(57) ABSTRACT

System and methods for administering travel arrangements for a household animal are provided. Attributes of the household animal, destination for the household animal, and transport used for travel to the destination can be used to evaluate whether the household animal is eligible to travel according to a travel itinerary, including boarding a transportation vehicle associated with the transport and arriving at the destination. One attribute of the household animal is whether the household animal is identified as a pet or as a service animal of the user. These techniques may allow for consumers and animal transportation providers to manage household animal documents in a centralized location and allow for streamlined compliance with common carrier, trade association, international, federal, and state requirements for household animal transport as well as a streamlined booking process.

### CROSS-REFERENCE TO RELATED APPLICATIONS

This application claims priority under 35 U.S.C. §119(e) to U.S. Provisional Application Ser. No. 62/335,086, titled “Household animal transport clearinghouse platform and method of use thereof,” filed on May 12, 2016, the entire contents of which are incorporated herein by reference.

### FIELD OF THE INVENTION

Some embodiments described herein relate to a household animal transport clearing house platform and method for the use thereof which provides a centralized system for the storage of documents and centralized compliance with common carrier, international, federal, and state requirements for household animal transport and booking.

### BACKGROUND

Overall pet ownership has increased in the U.S., particularly in the past decade, and is now estimated at 68 million households. In particular, the percentage of households with dogs has been on a steady increase with current ownership levels nearly equally divided between dogs and cats. As household animals become progressively integrated into families, they are increasingly being viewed as “family members” rather than pets/companions, and more owners are traveling with their animals. Many commercial airlines, private airlines, bus lines, cruise ships, and rail lines allow and provide animal transportation. Additionally, 60% of the travel lodging industry allows household animals to stay with their owners and there is a significant upward swing in the number of residential apartments, condominiums, university housing, restaurants, as well as shopping malls, with policies that allow household animals on their premises.

Government rules and regulations for household animals exist for U.S. airlines as well as international airlines. The Federal Aviation Administration sums up the industry's “general procedures” by noting that most airlines limit the total number of pets, restrict them to pet containers for the entire flight, and require the animals to be harmless, inoffensive, and odorless. In most cases, owners also need to produce and present a recently-issued animal health certificate, typically within 14 days of the departure date, to satisfy the inter-state transfer regulations and/or produce other type of documentation to satisfy regulations for international travel. Airline-specific rules and regulations can vary widely from airline to airline, creating a particularly complex reservation and check-in process with variations depending on how the animal is to be transported: in cabin, excess baggage or cargo. Almost all airlines allow pets in the cabin. Some airlines do not allow pets to travel as excess baggage or cargo. Other airlines do not allow pets to travel as excess baggage and will only transport the household animal as cargo. In addition, there is wide variability among airlines regarding fees for animal transportation service, and in the types (breed and species) and weight/size of household animals allowed in cabin, excess baggage, and cargo. Beyond animal type, weight and location within an airplane, each airline determines their check-in procedures, number of household animals allowed per flight, breeds, weather restrictions, plane type restrictions, length of travel time, in-cabin travel container size, excess baggage and cargo size and type of container. Many airline policies vary for advance reservations and up-front payment of household animal transport fees.

Currently, the U.S. Department of Transportation (DOT) regulations (14 CFR 382) promulgated under The Air Carrier Access Act (ACAA) enable service dog owners to travel without restriction for air travel with an animal that meets the requirements for being a service dog. Currently, emotional support animal and psychiatric service dog owners are to provide the airline with an authorization letter from their mental health professional at least 48 hours in advance, in part to allow airlines to verify the letter's authenticity.

### SUMMARY

According to an aspect of the present application, an apparatus comprising at least one processor and at least one storage medium having encoded thereon executable instructions that, when executed by the at least one processor, cause the at least one processor to carry out a method for administering travel arrangements for a household animal associated with a user is provided. The method comprises receiving information identifying at least one attribute of the household animal, at least one attribute of a destination for the user and the household animal, and at least one attribute for a transport to be used for at least a part of travel by the household animal to the destination. The at least one attribute of the household animal comprises whether the household animal has been identified as a pet or as a service animal of the user. The method further comprises evaluating whether the household animal is eligible to travel according to a travel itinerary including boarding a transportation vehicle associated with the transport and arriving at the destination. Evaluating whether the household animal is eligible to travel according to the travel itinerary comprises determining, for the travel itinerary, a set of conditions to be met for the household animal to be able to board the transportation vehicle and/or permitted to travel to the destination. Determining the set of conditions comprises evaluating the at least one attribute of the transport, the at least one attribute of the destination, and the at least one attribute of the household animal including whether the household animal has been identified as a pet or as a service animal of the user. Evaluating whether the household animal is eligible to travel according to the travel itinerary further comprises outputting, in response to determining whether the set of conditions for the household animal is met, whether the household animal is eligible to travel according to the travel itinerary.

According to an aspect of the present application, at least one computer-readable storage medium storing computer-executable instructions that, when executed, perform a method for administering travel arrangements for a household animal is provided. The method comprises receiving information identifying at least one attribute of the household animal, at least one attribute of a destination for the household animal, and at least one attribute for a transport to be used for at least a part of travel by the household animal to the destination. The at least one attribute of the household animal comprises whether the household animal has been identified as a pet or as a service animal. The method further comprises evaluating whether the household animal is eligible to travel according to a travel itinerary including boarding a transportation vehicle associated with the transport and arriving at the destination. Evaluating whether the household animal is eligible to travel according to the travel itinerary comprises determining, for the travel itinerary, a set of conditions to be met for the household animal to be able to board the transportation vehicle and/or permitted to travel to the destination. Determining the set of conditions comprises evaluating the at least one attribute of the transport, the at least one attribute of the destination, and the at least one attribute of the household animal including whether the household animal has been identified as a pet or as a service animal. Evaluating whether the household animal is eligible to travel according to the travel itinerary further comprises outputting, in response to determining whether the set of conditions for the household animal is met, whether the household animal is eligible to travel according to the travel itinerary.

According to an aspect of the present application, a method for administering travel arrangements for a household animal associated with a user is provided. The method comprises receiving information identifying at least one attribute of the household animal. The at least one attribute of the household animal comprises whether the household animal has been identified as a pet or as a service animal of the user. The method further comprises determining at least one travel itinerary option for which the household animal would be eligible. Determining the at least one travel itinerary option comprises determining, based at least in part on the at least one attribute of the household animal, whether for each of a plurality of combinations of a destination, from a plurality of destinations, and a transport, from a plurality of transports, whether the household animal would be eligible to travel based on a travel itinerary including the destination and the transport. The method further comprises in response to determining that the household animal would be eligible to travel based on a travel itinerary including the destination and the transport, identifying the travel itinerary as a travel itinerary option of the at least one travel itinerary option, and outputting the at least one travel itinerary option for presentation to the user.

### BRIEF DESCRIPTION OF THE DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 is a flow chart illustrating an exemplary method of operating a household animal transport clearinghouse platform according to some embodiments of the present disclosure.

FIG. 2 is a chart identifying potential steps, based on the type of animal, of an exemplary method of operating a household animal transport clearinghouse platform according to some embodiments of the present disclosure.

FIG. 3 is an exemplary system that administers travel arrangements for a household animal associated with a user.

FIG. 4 is a flowchart illustrating an exemplary method for administering travel arrangements for a household animal.

FIG. 5 is a flowchart illustrating an exemplary method for evaluating whether a household animal is eligible to travel according to a travel itinerary.

FIG. 6 is a flowchart illustrating an exemplary method for validating status of a household animal as a service animal.

FIG. 7 is a flowchart illustrating an exemplary method for determining travel itinerary options for which a household animal would be eligible for travel.

FIG. 8 is a flowchart illustrating an exemplary method for determining a risk score associated with a travel itinerary option.

FIG. 9 is a block diagram of a computing device with which some embodiments may operate.

### DETAILED DESCRIPTION

Described herein are techniques for administering travel arrangements for a household animal associated with an individual. In accordance with some embodiments described herein, a system for administering travel arrangements of a household animal may evaluate an eligibility of the household animal to travel on a travel itinerary. An evaluation of eligibility may include determining conditions that are to be satisfied for the household animal to be eligible to travel. The determination of eligibility and/or the conditions may be performed based on a specific set of factors, including based on attributes of the household animal, attributes of a destination, and attributes of a transport. The attributes of the animal may include whether the animal is a service animal, such as whether the animal is an emotional support animal, a service dog or other type of service animal. Through evaluation of the specific attributes, a specific set of conditions may be generated in some embodiments, which may be used in administering travel arrangements for the household animal. In some embodiments, the system may calculate a prediction of whether a household animal will ultimately be eligible to travel a particular itinerary on a travel date, and/or whether the animal will successfully complete the travel. Such a prediction may be qualitative and/or quantitative and in some embodiments may be generated by a trained system, such as a machine learning engine.

A household animal may be considered an animal that is noncommercial and acts in the role of pet (including show pets like show dogs), or a service animal including a service dog or an emotional support animal, or other animal that is kept and travels for the benefit of the owner and/or the owner's enjoyment and may live in the owner's home. As used herein “service dog” may refer to an animal, including a dog or any other animal of a species other than dog, including miniature horses and capuchin monkeys, that is trained to perform tasks to assist a person having a disability or medical condition, such that the animal may take an action to prevent an instance of or mitigate an effect of the disability or condition on the person. Such service dogs may include guide animals trained to assist a blind person with navigating an environment, animals trained to alert a diabetic person when his/her blood sugar reaches high or low levels, animals trained to remind a person with depression to take a medication, animals trained to detect the onset of a seizure in an epileptic person and then help the person remain safe during or following the seizure, or animals trained to sense the onset of an anxiety attack in a person and take an action to prevent or mitigate the anxiety attack. Psychiatric service animals (including psychiatric service dogs) may qualify as service dogs. The use of the term “service dog” herein to refer to both dogs and other types of animals that are trained in this way is consistent with the usage of this terminology in the service animal industry. Animals that are kept and transported for commercial purposes, such as livestock, are not household animals.

Different factors may impact eligibility of a household animal to travel with an owner according to a particular travel itinerary (e.g., airline flight, train ride). These factors can include regulations and restrictions that vary across different travel destinations, modes of travel, types of transportation vehicles or the vendors operating those vehicles, the type of carriers used to house the animal while onboard, weather conditions at a destination and/or way-points between the departure location and the destination, travel time frame, and many others. In addition, these restrictions can even vary in applicability depending on attributes of the household animal, such as the animal's breed, size, and/or weight. The regulations may also be found in different places, for example in national legislation or regulations (e.g., International Air Transport Association Live Animal Regulations, Federal Animal Welfare Act, the U.S. Department of Transportation), state or municipal legislation or regulations, private transportation terminal policies (e.g., airport policies), and private transport vendor policies (e.g., particular airline policies). Some of these may even be inconsistent, such as in a case where a federal regulation specifies one set of controlling factors (e.g., minimum temperatures for safe animal travel) but a transport vendor has a different set of controlling factors (e.g., a higher minimum temperature) to limit its potential problems and liabilities.

Individuals intending to travel with a household animal are confronted with these many factors when attempting to make travel arrangements for both the household animal and themselves, which can make travel for a household animal and oneself logistically complex and time-consuming. The plethora of regulations, rules, and guidelines within the domestic and international airline industry has led to traveler frustration and confusion.

In addition, this tangle of regulations/rules/guidelines has created fragmented and disjointed processes for airlines to manage travel by household animals. Frequently, individual airline employees become the de facto enforcers of this patchwork of policies to determine whether any particular animal qualifies, for in-cabin or cargo travel, as a service dog or whether an owner has presented satisfactory paperwork for an animal to qualify as an emotional support animal. The airline employee is placed in a position that is unsatisfactory to the employee, the airline, and the traveler, as the employee may also have difficulty interpreting and applying the patchwork of rules, regulations, and guidelines, which may lead to the employee creating nearly arbitrary rules in the role of “household animal enforcer” and “service dog enforcer.” Such arbitrary decisions may then create opportunities for tragedy, such as the well-publicized incidents of animals being injured or killed when they are not traveling in proper containers or are subjected to extreme hot or cold temperatures while traveling in violation of policies intended to protect the animals' health.

These difficulties also create opportunities for fraud. Owners of household animals have found very easy methods to secure service animal certificates and ID cards, or other documentation demonstrating that an animal is a service animal, without the animals truly qualifying for this status. This can cause income loss to airlines (as the airlines may charge for transporting an animal as cargo, but not for a service animal), customer dissatisfaction, and otherwise impact airlines' resources. In addition, it is notable that under current procedures such documentation is irrelevant for demonstrating the validity of a service animal to airline employees, so the entire fraudulent exercise is also wasteful for both animal owners and airline employees. The vast majority of owners of such “fake” service animals may also be unaware that such misrepresentation is a crime. For example, in California, any person who knowingly and fraudulently represents himself or herself, through verbal or written notice, to be the owner or a trainer of any canine licensed/qualified/identified as a guide, signal, or service dog shall be guilty of a misdemeanor punishable by imprisonment in the county jail not exceeding six months, by a fine not exceeding $1,000, or by both fine and imprisonment.

This difficulty with management of travel for household animals, including service animals, has persisted for years and is growing in visibility with frequent national media coverage. Unfortunately, airlines, household animal owners, and travelers continue to grapple with difficulties surrounding household animals, including issues related to service animals.

The inventors recognized and appreciated that the complexity of considering these different factors when arranging travel for a household animal can be mitigated with a focus on district attributes. In particular, the inventors recognized and appreciated that attributes of the household animal, a destination, and a transport used to travel to the destination may be used to control administration of administering travel arrangements for a household animal. One or more of these attribute categories can be used to determine different aspects of traveling with a household animal at different stages in the process, including scheduling travel arrangements for that animal and evaluating eligibility of the animal to travel.

In some embodiments, these attributes may be used in evaluating whether the household animal is eligible to travel according to a particular travel itinerary. One or more attributes of a household animal, a destination, and a transport may be used to identify one or more travel itineraries for the household animal and an individual associated with the household animal. As an example, an individual may input attributes of a household animal, including the animal's size and breed and a travel itinerary associated with a particular airline for traveling to a particular location. Determining eligibility of the household animal to travel to the destination may depend on what constraints, including governmental legislation or regulations (e.g., International Air Transport Association Live Animal Regulations, Federal Animal Welfare Act, the U.S. Department of Transportation) or airline-specific policies, need to be met before travel and whether the household animal has met conditions set by the compliance regulations. If constraints cannot be met, or cannot be met in time before a departure time of the travel itinerary, then the household animal may be not eligible for travel. In addition, constraints on whether the household animal can travel may depend on a transportation vehicle associated with the particular travel itinerary, such as on various dimensions of a door or holding space for a transportation vehicle.

One attribute of a household animal to consider in arranging and administering travel plans is whether the household animal is categorized as a pet or as a service animal, including a service dog or an emotional support animal, or other type of support animal. A pet can be considered as a household animal (e.g., dog, cat) that is not designated as a service animal or is not trained or intended to assist a person with a medical need. A service animal, in contrast, may be trained or otherwise intended to fulfill a medical need of a person, either a situation-specific medical need (e.g., a medical need that arises when traveling, such as anxiety connected to flying) or a more general medical need (e.g., a dog trained to assist a person with a vision disorder to navigate their surroundings). A service dog, which in some other cases may be a miniature horse, capuchin monkey, or other animal is trained to do work or perform at least one task or otherwise take an action to assist with fulfilling a person's medical need, such as by preventing or mitigating an effect of a disability or medical condition, including while the person is traveling and at the destination. Service dogs are generally trained to behave in public settings, including being housetrained, trained to remain under control of a handler, and not act aggressively, disruptively, or destructively. When traveling, service dogs are not typically placed on a seat or otherwise do not take a passenger's space. Other types of service animals, including emotional support animals (ESAs), qualify as such based on different regulations and assist with a person's disability while traveling or at the destination. Such a disability may be mental/neurologic, such as a psychiatric disability. An emotional support animal may reduce the likelihood or effects of a panic attack or other symptom or result of the disability in a person by the animal's presence and proximity to the person. Emotional support animals and other types of support animals may not necessarily be trained to perform work or a task to assist with a person's disability, in contrast to a service dog. In addition, emotional support animals may not be as extensively trained as service dogs, or may not be trained.

Other attributes of a household animal that may be important in arranging travel plans or administering travel of an animal include the animal's species, breed, size, weight, age, health, training, medical history, behavioral history (including any instances of aggressive behavior toward other animals or humans), identification for the animal, and any other information describing or characterizing the animal or its behaviors. Travel restrictions may apply to an animal depending on one or more of these attributes. For example, certain species of animals, including dog, cats, and miniature horses (e.g., horses that detect hypoglycemia), can be accommodated for travel with a person. The breed of an animal may impact the ability of a household animal to travel. For example, some breeds have respiratory challenges such that travelling at low oxygen levels (8000 feet) may put the animal at risk. Size of the animal may limit where the animal can be located on a transporter (e.g., airline carrier, train) during travel. On an airline carrier, household animals that are allowed to travel in the cabin of the carrier may fall under a particular size threshold, while larger animals may be required to travel in a cargo area of the airline carrier. Size and/or weight of the animal may also impact whether the animal can be held in a crate or other suitable holding container to house the animal during travel in cargo. Many transporters restrict transport of household animals to those over a particular threshold age. For example, because many animals younger than eight weeks may not have sufficient vaccinations, transporters may permit animals to travel only after reaching a particular age. Government regulatory restrictions may require that household animals meet particular health standards, including documentation that the animal received certain procedures, such as immunizations (e.g., rabies vaccination), blood tests, and training. Some health procedures may have time sensitivity with advance preparation required and be required well in advance of the travel departure date (e.g., 2-4 weeks prior to departure).

Attributes of a transport may include characteristics relating to a mode of transportation (e.g., air, rail) between departure location and a destination and characteristics of a transportation vehicle (e.g., airline carrier, train) associated with a mode of transport. While both the household animal and its owner may travel on the same transportation vehicle, such as when the animal is a service dog or an emotional support animal, it should be appreciated that the household animal and owner may travel on separate transportation vehicles in some cases. In some instances, only the household animal may travel to the destination, for example when the owner is already at the destination or the household animal is traveling to the destination prior to arrival of the owner. Attributes of a transport that relate to characteristics of a transportation vehicle may include a type of transportation vehicle (e.g., a type of plane, such as a “Boeing 747”). The type of vehicle may, in some embodiments, be used to identify other characteristics of the transportation vehicle, which may also be used to determine whether a household animal may travel on the transportation vehicle. In the context of airline carriers, for example, once a plane type is identified, other characteristics of the plane may be inferred, including whether the cargo area is pressurized for that type of plane, a size of the door in the cargo area of that type of plane and whether the door can accommodate animal crates, a number of animals the plane type allows during transport either in the cabin (which may be referred to as “above the wing” capacity) or in the cargo area (which may be referred to as “below the wing” capacity). The number of animals allowed during transport either “above the wing” or “below the wing” may depend not only on the type of plane, but also airline specific policies, in some cases.

Other transport attributes include a vendor (e.g., airline, train company) providing transportation services and travel schedules associated with the vendor, where an individual schedule may include a departure time from a departure location, an arrival time at a destination, and any locations that are way points between the departure location and the destination. Transport attributes may include other conditions for an animal to board, such as types of required documentation, or restrictions required by particular vendors, including whether a vendor has travel restrictions based on breed, species, or size of household animals. For example, some transport vendors may prohibit pit bull dogs or other specific breeds. Another type of transport attribute relates to whether a carrier used to contain a household animal traveling in a cargo area, excess baggage, or in some cases, the cabin, complies with regulations (e.g., International Air Transport Association Live Animal Regulations, Federal Animal Welfare Act, the U.S. Department of Transportation), which can include whether the size and/or sturdiness of the carrier meets such regulations. The size of the carrier may impact whether the household animal can stand up and turn around while inside the carrier. The sturdiness of the carrier may need to comply with certain governmental regulations such that a household animal is unable to destroy the carrier (e.g., chew through the carrier) during transport. This may, in some cases, be based on attributes of the animal, such as in a case where an airline has different size or sturdiness requirements for different breeds.

Attributes of a destination may include attributes of a final destination of an itinerary, as well as any attributes of any intermediate destinations or waypoints during an itinerary that are destinations of particular travel legs of the itinerary (e.g., layovers in the context of airlines). Destination attributes may include governmental legislation or regulations, including immigration, agriculture, and disease control regulations, that are applicable at the destination. As an example, Hawaii has specific regulations for rabies control and requires documentation of current rabies vaccination of any household animals traveling to Hawaii. These types of regulations may apply regardless of the category of household animal, such as whether the household animal is a pet, a service dog, an emotional support animal, or another type of support animal.

Weather, including weather at the initial origin, final destination, and any waypoints during travel, may be another type of destination attribute. Since a cargo area can be exposed to the elements when a transportation vehicle is at a particular location (e.g., when an airplane is on the tarmac), the ambient weather at the location may prohibit the household animal from traveling to the location even if that location is not the final destination. Some regulations only allow household animals to travel in the cargo area if the ambient temperature at a particular destination or waypoint is above or below a particular threshold temperature, such that the household animal is not harmed due to exposure to extreme hot or cold temperatures. Other environmental conditions (e.g., rain, snow, humidity, smog, wind) may also be considered in some cases. Weather at an origin may also be an attribute that is considered, in some embodiments.

It should be appreciated that the examples of household animal attributes, transport attributes, and destination attributes are not limited to those described as it is possible to implement other types of household animal, transport, and destination attributes in accordance with any of the techniques for arranging and administering travel for a household animal described herein.

Some embodiments of the present application include a logistics platform that reduces the complexity of passenger reservation and check-in, provides validation of service animals, identifies household animals that are a no show at check-in resulting in lost fees for airlines that do not charge in advance, reduces negative employee experiences, and improves overall passenger experiences and loyalty.

The present application provides techniques that allow for simplifying the household animal transportation travel process by creating a platform that acts as the key intermediary on the various forms, certificates, and documentation associated with household animal travel on airplanes, trains, and other approved mass transportation systems.

Also described herein are embodiments of a platform that ties the various parties in the travel process together via a centralized clearinghouse platform. The platform may serve as a repository of key information, documentation, and access points to facilitate the household animal travel process.

The present application provides several improvements over conventional methods for administering travel arrangements for household animals. Some embodiments may allow airlines to lower their reservation costs by utilizing the end to end interaction with household animal owners. Some embodiments include a website for reservation requests, an optional inbound and/or outbound call center, optional capacity management of household animals on flights, processing and recording of passenger acknowledgement and fulfillment of airline specific policies and government regulations, processing of airline fees for household animal transport, generation of guidance to passengers of the type of travel documentation required, optional enablement of passengers to upload required information in a single secure repository, optional tracking of passenger submission of documentation, optional validation of appropriate passenger compliance with U.S., individual state, and foreign government regulations for transport of household animals. Some embodiments may maintain a rules-based system of government regulations and airline guidelines that facilitates and optimizes the overall guidance given to household animal owners. It is understood that aspects of the present application may have connection points to one or multiple third party systems including, but not limited to, appropriate state and federal departments or agencies overseeing animal transport, government agencies for international transport, Veterinary practice management systems and animal health certificate providers/registries. Some embodiments may issue a branded boarding pass with a human readable representation as well as a computer interpretable manifestation (e.g., with one or more symbols by which information may be encoded, such as a “ID” or “2D” barcode) that can be presented at the airport in order to expedite processing and boarding.

Some embodiments may allow airlines, cruise ship providers, bus lines, rail lines, animal cargo companies, and animal veterinarian management solutions to increase revenue by making “fake” service animals, psychiatric service animals, and emotional support animals (hereafter referred collectively as “falsified service animals”) instead compliant with legal and regulatory travel guidelines and fees. The prevalence of falsified service animals is expensive for the airlines and other common transporters in terms of a high level of employee engagement, increased risk of passenger dissatisfaction, as well as increased weight that impacts fuel costs, in addition to the loss of fees charged by the carriers for the transport of falsified service animals. The decrease in falsified service animals may be accomplished by leveraging some embodiments of the present application for validation of documents based on the Air Carrier Access Act, and/or other government guidelines and regulations, via household animal owner attestations and/or review of submitted documents or documents submitted on their behalf (for example from a mental health professional). An attestation may be an acknowledgement made by the owner indicating the household's animal status as a service animal, which may include attesting to any of the requirements imposed on service animals by government or private policies or regulations, such as by attesting to a type of training the household animal received or a behavioral history of the household animal (e.g., a lack of history of aggression). When submitting an attestation, the owner may be reminded of any penalties associated with lying or providing false information. Some embodiments may include a reservation process where the passenger may be asked to acknowledge that the false representation of a falsified service animal may be illegal and may result in civil and criminal penalties. Fewer falsified service animals may reduce the potential for negative media publicity and disruption of other passengers. In addition, the airlines can increase revenue, since the falsified service animal owner, in a preferred embodiment, is redirected to the option of the present invention booking process for compliant household animals, which may include the collection of fees charged by the carrier and/or acknowledgement of the fees based on each individual carrier's fee schedule.

Some embodiments may include an option to collect the household animal owner's transport fees associated with the household animal, established by each airline, at time of reservation. As a result, there is not a revenue loss when a passenger has reserved one of a limited number of available spots for a household animal but does not bring the household animal for travel, as the passenger will have already paid for that reservation. If the household animal owner does cancel the reservation, some embodiments may have the ability to validate the viability of a cancellation based on an airline's stated policies and only issue a refund if the cancellation is compliant with policy.

Some embodiments may result in common carrier's and airline's employee training expenses being reduced. Some embodiments may include a centralized and automated rules-based system for household animal travel that includes each airline's specific policies regarding the transport of household animals. Because the system includes these policies, the system may eliminate any need for employee discretion, or even employee participation in the process of determining a household animal's eligibility to travel. Employees may therefore not need to be trained on the procedures, or may be trained to a lesser degree because the employees may no longer be expected to leverage their training in making discretionary decisions. This may eliminate time consuming and stressful activities for airline employees in processing household animals. Instead, the systems of some embodiments may serve as the household animal “enforcer” to ensure the documentation and animal health documentation is intact, fees have been paid, and weight, breed, and carrier dimensions are in compliance with each individual airline's guidelines this may significantly reduce the need for an airline employee to serve as the “service animal” enforcer.

The techniques of the present application may empower a household animal owner the opportunity to travel with confidence and ensure they are in compliance with airline regulations, have a confirmed reservation for their household animal, and are prepared for the airport check-in with appropriate documentation. By creating profile(s) of their animal(s), the household animal owner may be able to book additional flights through multiple carriers without needing to create an animal profile for each airline or flight. The system may serve as an animal registry for travel related documentation and certification. In particular, for service animals, a single profile may be very valuable for the household animal owner because it offers the opportunity to simplify future travel, including storing an approved letter from the mental health professional in a repository for future use, thereby reducing the need to re-submit paperwork. In some embodiments, the household animal owner may enjoy and utilize additional third party services available in a branded marketplace, that may include travel related merchandise, such as animal transport carriers, as well as recommendations for their destination city that includes animal walking and sitting services, animal friendly lodging, on-call veterinarians, emergency veterinarians that can meet the animal owner at the airport if there is missing documentation, animal food delivery, and household animal cargo company recommendations. Some embodiments may enable the traveler to experience benefits through the airline that increases the likelihood of repeat travel with the airline.

Some embodiments establish a rules-based system in the platform to incorporate airlines' specific regulations and guidelines that may include the number of household animals allowed on each specific airline type, time of year, weight restrictions for various types of carriage including in-cabin and excess baggage, type of breed and applicable fees. The rules-based system may also include domestic and international government regulations. The rules engine may enable some embodiments to book and provide boarding information germane to a specific airline.

In some embodiments, upon completion of passenger flight travel booking, an airline may direct the passenger to the platform to request a reservation for their household animal. Some embodiments may receive and/or retrieve (via a push or pull mechanism for transferring information) reservation information electronically from the airline reservation system, global reservation system, travel aggregator booking systems, or other system that is separate from and external to the platform. The household animal owner may create a profile with the system and submit a request for a reservation based on a specific household animal category of animal, i.e. household pet, service dog, psychiatric service animal, emotional support animal or other category. Household animals may be allocated into airline-designated transport categories, such as in-cabin, excess baggage, and cargo.

Some embodiments may confirm or deny a reservation to the airline booking system and/or to the system, and may provide a description of the animal and transport category (in-cabin, cargo, excess baggage) of a household animal reservation that is being confirmed or denied, and in the case of a denial may provide an explanation of the denial.

In some embodiments, the household animal owner may upload appropriate documentation (including, for example, clinical documentation from licensed healthcare professionals of the user, animal certificates of health from a veterinarian for the animal, or other necessary documentation) within the specified timeframes and some embodiments may confirm or flag missing documentation leading up to date of travel. In the case of clinical documentation, a certified healthcare professional may in some embodiments review the documentation on behalf of the platform (and/or on behalf of the airlines or other transport vendors) to validate that the household animal owner is authorized by their clinician (e.g., doctor, physician's assistant, psychologist, nurse, or other licensed medical professional) to travel with an emotional support animal or psychiatric service animal, such as that the animal is fulfilling a medical need of the owner. The professional who reviews the documentation may be different from the clinician that authored the documentation in some embodiments, to provide an independent review. The status and/or confirmation of the household animal may be transmitted electronically to the appropriate airline. In parallel, some embodiments may provide the airline with data and trends for airline household animal travel.

In some embodiments, the user may submit an attestation declaring that the household animal is a service animal. Submission of the attestation may include the user answering a series of one or more questions, including questions related to the status of the household animal. The attestation may have the form of a legally-binding statement that holds the user accountable for its content. In some embodiments, the attestation may serve as a validation of the household animal's status, in place of other forms of validation such as submission of documentation for review. In some embodiments, a user may be able to submit an attestation through a user profile. If the user has made a reservation prior to submitting an attestation, then the user may be prompted to create a user profile associated with the household animal such that the attestation can be submitted prior to departure.

Some embodiments may provide a contact center to address questions and issues from household animal owners and airline employees. Some embodiments may conduct customer service surveys at conclusion of travel process in order to capture and develop the service.

In some embodiments, the household animal transport clearinghouse platform issues a branded electronic boarding pass, with a human readable component as well as a computer readable manifestation (the manifestation may include a computer readable code and/or physical device attached to the household animal or its carrier) that enables an airplane employee to know that the household animal has conformed to airline policies and procedures as well as government rules and regulations for the flight. In addition, the airline has access to a harmonized view of the documentation associated with an individual household animal owner's flight.

Some embodiments may offer on-call veterinarian services for house calls and at airport visits in order to examine household animals and issue appropriate animal health documentation. Some embodiments may interact with animal health business management software, animal movement software, animal transport providers, and government repositories for animal health certificates in order to streamline and simplify the tracking of animal documentation for the household animal owner, airline, and other interested parties.

Some embodiments may provide a marketplace that offers services related to household animal travel that can be marketed to household animal owners including, but not limited to, dog walking, pet food delivery, local veterinarians, lodging recommendations, and pet transport options.

Some embodiments may permit a household animal owner to register and create a personal online profile as part of using the household animal transport clearinghouse platform. The household animal profile may include, but is not limited to type of animal, breed, gender, weight, health issues, animal history, veterinarians, photos, emergency contact information, microchip information, health certificates and vaccinations with expiration dates, and state of residence. Depending on the regulations of the appropriate travel industry, individual states and countries, the household animal owner may upload appropriate documentation within appropriate guidelines and timeframes in order to ensure travel to meet regulatory guidelines. Some embodiments may allow the household animal owner to modify the animal profile to add, delete and alter information relevant to related animals as well as delete account altogether.

Based on airline availability, some embodiments may associate a household animal reservation to the household animal owner's travel reservation. The household animal owner may purchase an airline flight with associated reservation information. The transportation booking system may then communicate with the household animal transport clearinghouse platform such that the platform obtains reservation information identifying the travel, such as identifying an itinerary for the travel. The itinerary may include any suitable information on the travel, including a final destination, one or more waypoints, information about a transportation vehicle to be used for one or more of the legs of the travel, a travel length of one or more legs of the travel, a start time or start date of the itinerary, or other information about the itinerary.

Based on the information regarding the itinerary that has been obtained by the platform, the platform may begin identifying conditions that may need to be met for the household animal to be eligible to travel according to the itinerary. The platform may, for example, confirm with an airline or travel aggregator availability for a household animal on the transportation vehicle, such as by confirming whether there is available above- or below-the-wing capacity, as appropriate, for the household animal on the transportation vehicle for the travel or a particular leg of the travel. The platform may offer the airline the ability to outsource the load management of the number of household animals allowed in-cabin, excess baggage and cargo, depending on the airline guidelines.

In some embodiments, the household animal transport clearinghouse platform may provide the passenger with government rules and regulations and airline appropriate terms of service and guidelines for necessary documentation to be provided prior to travel and receive confirmation with electronic signature from the passenger.

Further, in some embodiments, the household animal transport clearinghouse platform may collect the animal processing fee from the household animal owner on behalf of a third party or for purposes directly related to the system.

In some embodiments, a household animal owner may upload documentation to a user profile. The documentation may include health documentation for either the household animal owner or the household animal. Accordingly, alternatively or additionally to the owner uploading documentation, a veterinarian or mental health professional may upload documentation to a client's user profile. The professional may obtain access through a secure procedure, such as a secure two-step authentication process.

The documentation that may be uploaded may be of any suitable type. As determined by government regulations and airline-specified guidelines, a household animal owner may secure from a veterinarian, mental health professional, or suitable resource appropriate documentation to ensure his/her animal will be eligible to travel. For a service dog, the owner is not mandated to provide any written documentation to the airline, at least according to current regulations. Because an emotional support animal is not considered a service dog, those rules do not apply, and a different set of rules under The Air Carrier Access Act (ACAA) apply instead. Under the ACAA, documentation may be required. In particular, the animal may only be allowed to accompany the owner in-cabin on a plane if a written document from a mental health professional is supplied to the airline 48+ hours in advance. For in-cabin, excess baggage, and cargo household animals, almost all jurisdictions require a veterinary health certificate or a rabies certificate certifying the household animals has been examined in the last 10 days and is healthy for transfer to another state(s) for domestic travel. Similarly, household animals require specific documentation for international travel, that generally includes at a minimum a veterinary health certificate. Through the upload of such documentation by health professionals for humans and/or veterinarians for animals, and/or by the animal owners, the household animal transport clearinghouse platform may become a repository of documentation for facilitating animal travel compliance.

In some embodiments, the household animal transport clearinghouse platform may simply store uploaded information. In other embodiments, based on regulations, for either veterinarian-issued certificates or mental health certificates, the system may trigger a contact to an appropriate medical health professional or associated clinical office to verify documentation's veracity. In some embodiments, the platform may have interfaces with animal patient management systems and health documentation systems to provide for the electronic transfer of health information that has been uploaded to the platform.

The household animal transport clearinghouse platform may provide credential validation to the travel provider with status updates and will unify the various health certificates and other documentation into a common user interface, simplifying and streamlining the process for airline employees to interact with animal owners.

Some embodiments may regularly issue, automatically or manually initiated, communications to household animal owners on documentation status, travel restrictions (i.e. carrier size), reminders to submit paperwork within prescribed guidelines, confirmation of documentation received, and upcoming travel information, including marketplace providers.

The household animal transport clearinghouse platform may issue an electronic document (boarding pass) confirming the household animal owner has met the travel provider's individual criteria. The airport airline employees utilize the boarding pass to validate the animal has been processed for travel on the specific flight.

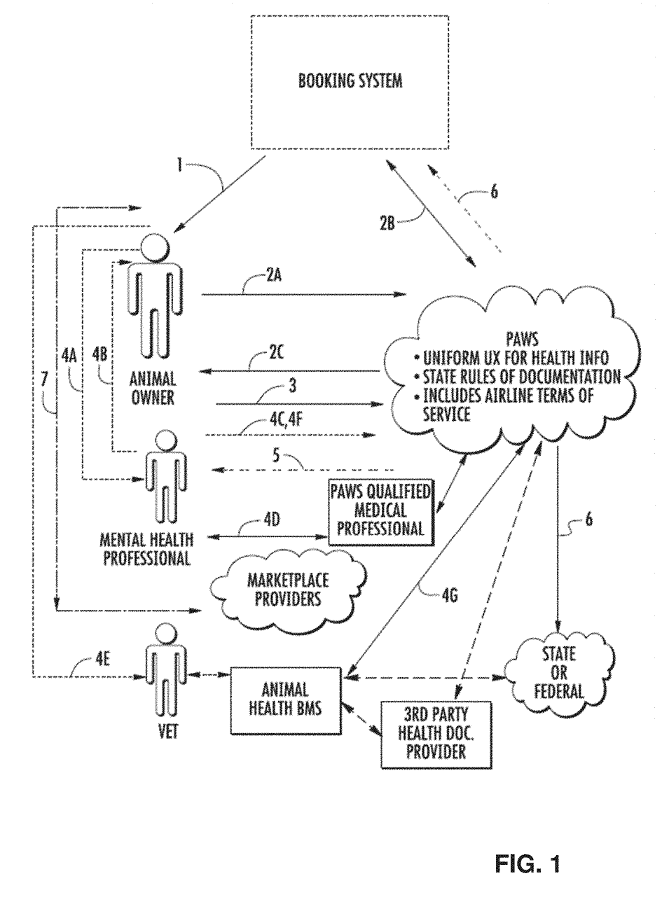

Various embodiments of systems implementing techniques described herein are described below in connection with FIGS. 1-9. It should be appreciated, however, that embodiments are not limited to operating in accordance with any of these specific illustrative examples, and that other embodiments are possible.

In addition, in various embodiments described below, examples are discussed in terms of a “user” of a system being an owner of a household animal that is to travel according to a travel itinerary, and/or that the user will also be a passenger and accompany the household animal on the travel. This may be the case, for example, where a service animal is described as being a service animal of the user, or that is to fulfill a medical need of the user. It should be appreciated that embodiments may operate with users who are different from the person whom the service animal supports. For example, a user may be a travel agent, friend, or relative who is booking travel on behalf of another person and assisting with the logistics of the person's travel with a service animal, or otherwise assisting with the logistics of the person's travel with a household animal. Accordingly, in some embodiments, a “user” of the system may not be a passenger who will travel according to a travel itinerary and/or may not be an owner of a household animal, and/or may not be an owner who will accompany a household animal as a passenger on travel. In addition, while examples may be given in which a user or passenger corresponding to a household animal is an “owner” of the animal, it may be that the corresponding person may not be an owner of the household animal but may have any other relationship to the household animal, including that the household animal is temporarily or permanently assigned to assist the person. In addition, in some embodiments, it should be appreciated that a user may coordinate travel for a household animal that will not be traveling with a passenger, such as a household animal that will be traveling as cargo to a destination an owner or other person is already at or otherwise traveling without a person.

In addition, for ease of description, the examples below are discussed in terms of a travel itinerary including a single transport vendor, such as a single airline. Those skilled in the art will understand how to extend the techniques described for use with multiple transport vendors, through identification of and communication with multiple computing devices for the multiple vendors.

FIG. 1 shows a flow chart illustrating an exemplary method of operating a household animal transport clearinghouse platform according to the present application. Method 100 includes multiple rules-based potential pathways through the flow chart based on the type of animal, whether a household animal (which, depending on each airline's policies, may be transported in-cabin, as excess baggage, or as cargo) or whether the household animal qualifies as a service animal, including an emotional support animal, a service dog, or other type of support animal. The platform discussed in connection with FIG. 1 may be implemented as one or more software facilities executing on one or more computing devices,

The method 100 may begin when a common carrier or airline sends (1) a passenger flight information for a travel itinerary. The travel itinerary may include information such as a flight number and travel itinerary confirmation number.

In a second step, the passenger may establish (2A) a profile with a platform, and submits to the platform a request that a household animal reservation may be linked to the travel they have booked with the airline. The passenger may provide, as part of the request, the travel itinerary confirmation number and, in some cases, an identification of the transport vendor with which the travel has been booked. The platform may identify one or more remote computing devices associated with the transport vendor for the travel itinerary, and may query the remote computing device(s) for information on the travel itinerary, such as by communicating the confirmation number to the remote computing device(s). The platform may then obtain (2B) information on the travel itinerary, which may include one or more attributes of the transport and/or one or more attributes of the destination. The platform may also associate the flight reservation with the user's household animal transport clearing house platform profile.

The platform may then begin determining an eligibility of the household animal to travel according to the travel itinerary. In some embodiments, the platform may determine eligibility of the household animal to travel to a destination without a particular travel itinerary. The transport attributes received from the transport vendor may include animal availability on the specific travel itinerary that the user is to travel, such as an animal availability above- or below-the-wing on specific transportation vehicles that the travel itinerary includes. As part of determining availability, the platform may evaluate attributes of the household animal, such as whether the household animal will travel as a service animal, including as an emotional support animal, of the passenger and information describing the animal such as a species and breed of the animal. In some cases, the platform may identify from the species and breed information rough dimensions of the animal, based on average dimensions of animals of that species and breed. The platform may evaluate these attributes in some cases because the transport vendor may include limitations on how many animals of a particular species may travel in one vehicle (e.g., a limit on a number of dogs) or may include limits on a size of animals. In other embodiments, though, the system may merely use the information obtained from the transport vendor to compare a number of animal reservations that the transport vendor and/or particular type of transportation vehicle may accommodate, and determine (from the information) how many of those have already been reserved for use by other animals, to make the availability determination.

The platform may also obtain conditions to be met for the household animal to be eligible to travel, based on specific attributes of the animal, of the transport and/or the travel itinerary, and of the destination (including the ultimate destination and/or one or more intermediate destinations of the itinerary).

The household animal transport clearinghouse platform may communicate (2C) the specific flight's animal availability based on the household animal and household animal owner profile information, and provides the identified conditions for the household animal to be eligible to travel on the travel itinerary. The platform may also communicate to the passenger a message describing potential penalties for false representations about the status of the animal as a service animal.

The third step (3) requires the passenger to acknowledge all terms of travel with the animal including the terms of the carrier or airline, the terms of the household animal transport clearinghouse platform, and any government regulations.

Next, the fourth step includes the household animal owner taking action to try to meet the conditions for eligibility of the household animal to travel according to the travel itinerary. This step may include multiple possible sub-steps depending on the conditions, which themselves may be dependent on a variety of factors such as the carrier or airline's specific policies, the status of the animal, such as a household pet or a service animal, and the possible methods of transport available to the animal on a given flight, such as in-cabin, excess baggage, or in cargo. In some embodiments, the passenger requests (4A) documentation from a mental health professional to verify that an animal is an emotional support animal. The mental health professional will then generate (4B) the documentation, if appropriate. The passenger will upload (4C) the mental health documentation to the household animal transport clearinghouse platform. The household animal transport clearinghouse platform may then validate (4D) the document with the health care professional. In some embodiments, the passenger requests (4E) documentation from a veterinarian to verify that an animal healthy enough to travel and up to date with all required vaccinations. The passenger may upload (4F) the veterinarian approved animal health documents to the household animal transport clearinghouse platform. As an optional step in some embodiments of the present application, the household animal transport clearinghouse platform may then validate (4G) the documentation with the veterinarian or receive documentation directly from the veterinarian.

The fifth step involves the household animal transport clearinghouse platform issuing (5) an animal boarding pass, which may optionally be branded, to the animal owner or passenger. The animal boarding pass is in a format that may include but is not limited to a human readable component as well as a computer readable manifestation (the manifestation may include a computer readable code and/or physical device attached to the household animal or its carrier) that enables the airplane employee to know that the household animal has conformed to airline policies and procedures as well as government rules and regulations for the flight. In addition, the airline has access to a harmonized view of the documentation associated with an individual household animal owner's flight.

The sixth step involves the household animal transport clearinghouse platform providing (6) data to the carrier or airline including but not limited to credential validation, status updates, payment of animal transport or processing fees, unified various health certificates or equivalent information in a format with a common user interface, and notification to state and federal regulatory (e.g., U.S. Department of Transportation) body, foreign governmental body or trade association (e.g., International Air Transport Association) (if applicable).

The seventh step pertains to the optional inclusion of a marketplace which will offer the household animal owner and/or passenger access to vendor services including but not limited to dog walking services, food delivery, destination vet services, pet sitting services, and grooming services.

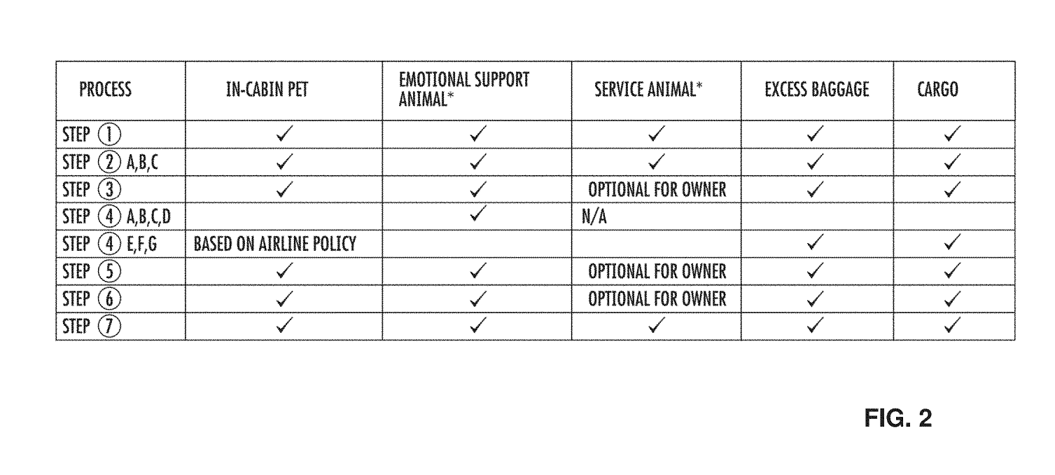

FIG. 2 is a chart identifying potential steps, based on the type of animal, of an exemplary method of operating a household animal transport clearinghouse platform according to the present application. In some embodiments, the specific steps of method 100 will depend on a variety of factors such as the transporter or airline's specific policies, the status of the household animal, such as a household pet or a service animal, and the possible methods of transport available to the animal on a given flight, such as in-cabin, excess baggage, or in cargo.

In some embodiments, as shown in the chart in FIG. 2, if a household animal qualifies as an in-cabin household animal, the method 100 may include but not be limited to steps 1, 2A, 2B, 2C, 3, 4E, 4F, 4G, 5, 6, and 7. The inclusion of steps 4E, 4F, and 4G will be based on the carrier or airline's policies and requires for veterinarian certified health documents for the transport of animals.

In some embodiments, as shown in the chart in FIG. 2, if a household animal qualifies as an emotional support animal, the method 100 may include but not be limited to steps 1, 2A, 2B, 2C, 3, 4A, 4B, 4C, 4D, 5, 6, and 7. The inclusion of steps 4A, 4B, 4C, and 4D will be based on the carrier or airline's policies and requires for a mental health professional for the classification and transport of emotional support animals.

In some embodiments, as shown in the chart in FIG. 2, if a household animal qualifies as a service dog, the method 100 may include but not be limited to steps 1, 2A, 2B, 2C, and 7. The inclusion of steps 3, 5, and 6 will be optional due to required accommodations and exemptions for service animals on common carriers and airlines.

In some embodiments, as shown in the chart in FIG. 2, if a household animal does not qualify as either eligible for in-cabin transport, as an emotional support animal, or a service animal then the method 100 may include but not be limited to steps 1, 2A, 2B, 2C, 3, 4E, 4F, 4G, 5, 6, and 7.

The embodiments detailed in FIG. 2 are examples based on the current regulation landscape and it is understood that this process may change to embrace any alternations to local, state, federal, or international regulations or airline policies, as may happen from time to time.

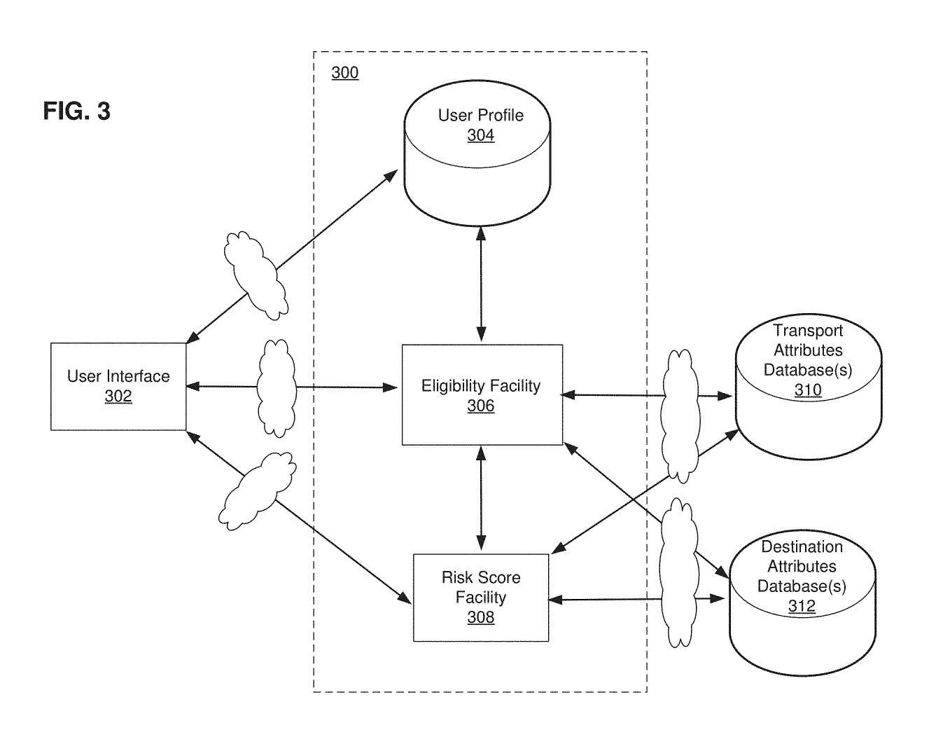

FIG. 3 illustrates a travel arrangement system 300 with which some embodiments may operate. The travel arrangement system 300 of FIG. 3 includes a user profile 304, an eligibility facility 306, and a risk score facility 308. The facilities 306, 308 may execute on one or more computing devices, which may be one or more physical or virtual servers, such as virtual servers provided by a cloud computing platform or a physical computing device functioning as a web server, or as any other computing device. A user, who may be a passenger and/or owner of a household animal, may input information into the travel arrangement system 300 through a user interface 302. Embodiments are not limited to working with a particular user interface 302 or type of user interface 302 and, as such, embodiments may operate with a user interface that is a webpage-based interface, a mobile “app” based interface, an interface of an application designed for execution by a laptop or desktop personal computer, a telephone interface, a voice response interface, or other interface. The user interface 302 may be implemented in a computing device separate from the computing device(s) on which the facilities 306, 308 execute. Information input to the user interface 302 may be communicated to the facilities 306, 308 via one or more wired and/or wireless computer communication networks, including the Internet.

Information inputted by a user into travel arrangement system 300 may include one or more attributes of a household animal associated with the user. An attribute of the household animal may include whether the household animal is identified as a pet or a service animal of the user. Information associated with the user and the household animal may be stored in user profile 304. The user profile 304 may be stored in any suitable data store, including in one or more databases.

Travel arrangement system 300 may determine whether the household animal is eligible to travel according to one or more travel itineraries. To that end, the system 300 receive information identifying a destination for the user and the household animal, one or more attributes of the destination from destination attributes database(s) 312, and one or more attributes for a transport to be used for travel by the household animal to the destination from transport attributes data store(s) 310. In some embodiments, system 300 may receive information identifying one or more attributes of the origin location for the user and the household animal.

Specifically, the eligibility facility 306 of the travel arrangement system 300 may receive and/or retrieve information from the transport attributes database(s) 310 to evaluate whether a household animal is eligible to travel according to a travel itinerary. This may include, for example, identifying a transport on which the household animal would travel as part of the travel itinerary, such as by prompting the user for this information via the user interface 302. The facility 306 may then communicate with the database 310 via one or more communication networks to retrieve information related to the travel itinerary. For example, the facility 306 may in some cases receive from the user, via a user interface 302, a booking confirmation number or other identifier for a travel itinerary. The facility 306 may then query the database 310 using the identifier for the travel itinerary, to receive information on the travel itinerary, including information on a destination of the travel itinerary and/or on the transport, such as transportation vehicles on which a passenger and/or household animal will travel as part of the travel itinerary. The facility 306 may then evaluate attributes of the household animal input via the user interface 302 in context with attributes of the transport and the destination to determine a set of conditions for the household animal to be eligible to travel according to the travel itinerary. The facility 306 may also determine whether the conditions are met, or can or cannot be met, and whether the household animal is or will be eligible to travel according to the travel itinerary. The facility 306 may output for presentation to the user the conditions and/or an indication of eligibility for the household animal, such as by outputting for presentation to the user via user interface 302.

Accordingly, in some embodiments, a user associated with the household animal may input information identifying a travel itinerary, such as a reservation code for an airline flight or other itinerary identifier, into travel arrangement system 300. Travel arrangement system 300 may then evaluate whether the household animal is eligible to travel according to the travel itinerary specified by the identifier. If travel arrangement system 300 determines that one or more conditions need to be met before household animal would be eligible travel according to the travel itinerary, then travel arrangement system 300 may provide information relating to those conditions (met and/or unmet) to the user. Such conditions may include additional required documentation, such as certification that the household animal is a service animal, and health records, such as immunization records of the household animal. In some embodiments, the conditions may include a required attestation by the user that the household animal has a status as a service animal. In this manner, travel arrangement system 300 may assist a user in identifying tasks specific to the household animal and the travel itinerary that needed to be taken prior to departure. Travel arrangement system 300 may send notifications to the user that a task has yet to be completed as a departure time associated with the travel itinerary approaches. The user may also input information into the system 300 as the user performs the tasks, allowing the system to track which tasks and/or conditions are met.

In the example described immediately above, facility 306 retrieves information using a booking confirmation input by a user. Such a system may be implemented in a circumstance in which the system 300 is separate from a booking system, and used by a user after finalizing (and, in some cases, after purchasing) travel with a booking system. It should be appreciated, however, that embodiments are not so limited and that travel arrangement system 300 can be integrated into one or more different stages of administering travel arrangements for a household animal.

In some embodiments, travel arrangement system 300 may be integrated as part of a registration process of building user profile 304. In such cases, a user may input one or more attributes of the household animal, including the household animal's name, species, breed, age, weight, and status as a pet or service animal. The one or more attributes may be stored in user profile 304. In some embodiments, creation of user profile 304 may occur prior to arranging travel plans for the household animal. In such cases, the information stored in the user profile 304 may be retrieved by a booking system and used to determine a travel itinerary for the household animal. In other embodiments, creation of user profile 304 may occur after a travel reservation has been made. In such instances, the user may input information into user profile 304 as part of the process of preparing to travel with the household animal according to a particular itinerary that has already been booked.

The information inputted into user profile 304, before and/or after booking travel, may be used to determine eligibility of the household animal to travel. The user may input information validating the status of the household animal as a service animal into user profile 304. In some embodiments, the validating information may include an attestation by the user declaring that the household animal is a service animal. The attestation may include a statement that holds the user legally accountable for its content stating that the household animal is a service animal. In some embodiments, the validating information may include required documents certifying the household animal's status as a service animal.

In some embodiments, travel arrangement system 300 may be integrated as part of a reservation process of a travel itinerary. In such cases, a user may input a desired destination and/or a desired time for traveling with a household animal associated with the user. Travel arrangement system 300 may identify one or more possible travel itineraries that allow the user and the household animal to travel to the desired destination and/or at the desired time inputted by the user. Additionally or alternatively, travel arrangement system 300 may identify a travel itinerary for which a household animal would be eligible to travel, by identifying possible locations, times, and/or transports for which the household animal can meet a set of applicable conditions. For an example, a user may only desire to travel at a particular time of year, such as when the user has a vacation, but may not know which destinations may allow the user to bring a household animal when traveling at that time and may only desire to know a list of destinations to which they could travel with their household animal. Travel arrangement system 300 may identify one or more travel itineraries for the user and the household animal to travel at that time based on whether the household animal is already eligible or may be able to become eligible, by completing one or more conditions beforehand, in time to travel according to the one or more travel itineraries. Travel arrangement system 300 may output one or more destinations associated with those one or more travel destinations. A user may select to reserve one of the travel itineraries identified by travel arrangement system 300. In such cases, travel arrangement system 300 may integrate with a vendor associated with the selected travel itinerary, which may allow the user to purchase one or more tickets associated with the travel itinerary. Information inputted by the user, including user preferences (e.g., preferred time of year to travel, preferred destinations), and identified by travel arrangement system 300, including identified travel itineraries and/or destinations, may be stored in user profile 304. The user profile 304 may ease arranging future travel plans for the user and the household animal by having information related to prior travel stored in the user profile 304.

In some embodiments, the travel arrangement system 300 may include functionality to inform a transport related to a travel itinerary, such as a vendor of transportation services that is to convey the passenger and/or household animal for a portion of the travel, of an outcome of an eligibility determination for the household animal. For example, the system 300 (e.g., the facility 306) may include an interface to exchange information with a vendor of transportation services, and may use the interface to send to the vendor a confirmation of a household animal complying with one or more conditions associated with a travel itinerary or a message that the household animal does not comply with the one or more conditions and thus that the travel may be canceled. In some embodiments, the system 300 may also update the vendor from time-to-time (e.g., occasionally, periodically, or otherwise) on progress of the owner of the household animal toward compliance with each of the conditions for the animal to travel according to the travel itinerary. For example, as the owner of the household animal completes or makes progress toward completion of tasks that satisfy conditions, the system 300 may inform the vendor of the completion or progress. The vendor may thus monitor eligibility of the household animal to travel by tracking compliance of the one or more conditions. Such monitoring may be useful for the vendor as a departure time associated with the travel itinerary approaches. With the updates from the system 300, the vendor may monitor whether the household animal has become, will become, or is likely to unlikely to become eligible. This allows the vendor to generate predictions of whether the household animal will be eligible to board a transportation vehicle when the departure time arrives.

A veterinary service provider (e.g., veterinarian, veterinary technician) may interface with travel arrangement system 300 to provide information that may be necessary for meeting one or more conditions associated with a household animal traveling according to a travel itinerary. The veterinary service provider may access travel arrangement system 300 through a suitable user interface, such as user interface 302. The veterinary service provider may provide health records and documentation to travel arrangement system 300, which may be stored in user profile 304. The veterinary service provider may provide vaccination information, microchip and inspection documents, which may be stored in user profile 304. Information provided by veterinary service provider may be used to evaluate eligibility of the household animal to travel according to a travel itinerary.

Eligibility facility 306 may receive information identifying one or more attributes of a household animal from a user, such as through user interface 302, and/or from user profile 304. An attribute of the household animal may include whether the household animal has been identified as a pet or as a service animal of the user. An attribute of the household animal may include the household animal's species, breed, size, weight, age, health status, vaccination status, training status, and any other suitable type of household animal attribute related to travel.

Eligibility facility 306 may receive information identifying one more transport attributes, which may be retrieved from transport attributes database(s) 310. A transport attribute may include a mode of transport, type of transportation vehicle, household animal cabin capacity, household animal cargo capacity, travel restrictions based on breed type, travel restrictions based on species, one or more policies instituted by a transporter that restrict household animal transport, and any other suitable type of transport attribute related to travel. A transport attributes database may be associated with an individual vendor of transportation services, and travel arrangement system 300 may query the transport attributes database based on one or more inputs provided by the user and/or retrieved from user profile 304. As an example, a user may input information identifying an airline reservation for a travel itinerary, such as a confirmation code associated with an airline flight, into travel arrangement system 300. Travel arrangement system 300 may retrieve, based on the information, one or more transport attributes from transport attributes database(s) 310, such as a type of plane and the destination associated with the reservation.

Eligibility facility 306 may receive information identifying one or more destination attributes, which may be retrieved from destination attributes data store(s) 312. A destination attribute may include a location of the destination, a location of a waypoint, destination government regulations, ambient weather at a destination, ambient weather at a waypoint, and any other suitable type of destination attribute related to travel. The destination to which the attribute information applies may include a final destination of a travel itinerary and/or one or more intermediate destinations such as waypoints on the itinerary (e.g., points of airline layovers). Information identifying a destination associated with a travel itinerary may by inputted by a user, retrieved from user profile 304, and/or determined based on information retrieved from a transport attribute database. For example, a confirmation code for a reservation may be used to retrieve a destination associated with the reservation from a vendor data store associated with the reservation. Information on attributes related to the destination, such as information on regulations that are applicable at the destination or a weather at the destination, may be retrieved by the facility 306 from one or more data sources. For example, in response to receiving information on a travel itinerary (which may be retrieved, e.g., using approaches described above), the facility 306 may determine one or more destinations of the travel itinerary, such as a final destination and, if applicable, one or more intermediate destinations. The facility 306 may then query one or more data sources, such as a data source of applicable regulations at a destination, including government legislation or administrative rules, private policies of the airline or airport at the destination, or other regulations. The data source may be a part of facility 306 or may be separate from facility 306, such as by being housed on a remote computing device with which facility 306 communicates via one or more networks. As another example, the facility 306 may query a weather data source to determine current weather, a short-term weather predication, and/or historical weather information for the destination. The facility 306 may then use some or all of this weather information as part of evaluating whether a household animal will satisfy one or more conditions.

A risk score facility 308 may determine one or more risk scores associated with a travel itinerary, such as a travel itinerary being evaluated by eligibility facility 306. A risk score determined by risk score facility 308 may indicate a likelihood that the household animal will be unable to (or able to) travel according to the travel itinerary. In some embodiments, risk score facility 308 may determine a qualitative risk score associated with a particular travel itinerary. The qualitative risk score may indicate for example a “low,” “medium,” or “high” level of risk. In some such embodiments, the qualitative risk score may be evaluated using one or more rules, such as rules that evaluate a number of conditions or a number of tasks necessary to satisfy one or more conditions. With increasing number of conditions/tasks, a higher qualitative risk may be determined, such as by having different thresholds associated with “low,” “medium,” and “high.” In other embodiments, risk score facility 308 may determine a quantitative risk score, such as a numerical value, probability, percentage or other suitable type of numerical representation associated with the amount of risk associated with a travel itinerary. Such a quantitative score may be determined in a variety of ways, including using a trained model generated and evaluated using a machine learning engine. The machine learning engine may be trained using data on past ability of owners of household animals to perform tasks or otherwise comply with conditions and the ultimate eligibility of the animal to travel according to an itinerary. The model may also be trained based on underlying data for the eligibility determination for the animal, including the set of conditions identified for the household animal to be eligible, attributes of the household animal, attributes of the transport, attributes of the destination, time, weather, or other factors. Once trained, the model may be used to generate a prediction for a particular household animal based on the set of conditions identified for the household animal to be eligible, attributes of the household animal, attributes of the transport, attributes of the destination, time, weather, or other factors. Risk associated with a particular travel itinerary and whether the household animal may be able to travel according to the travel itinerary at a departure time associated with the travel itinerary may depend on one or more factors.

Weather may in some cases particularly impact a household animal designated as traveling in a cargo area of a transportation vehicle, because the animal may be exposed to the ambient temperature and other weather conditions while at one or more locations in the travel itinerary. In addition, the difficulty of predicting weather may lead to difficulties in evaluating a likelihood of eligibility, as a change in weather may render a previously-eligible animal ineligible to travel. For example, if the ambient temperature at a location suddenly drops below or rises above particular threshold temperatures, then the household animal may not be allowed to travel because of restrictions intended to protect the animal's health. Risk score facility 308 may in some embodiments evaluate a current weather, a short-term prediction for weather, and historic data for weather, all at one or more destinations of an itinerary. Based on this analysis, the facility 308 may determine a risk score that indicates a likelihood that weather at the at least one location may negatively impact the ability of the household animal to travel according to the travel itinerary. Risk score facility 308 may determine such a risk score based on prior weather data corresponding to one or more locations associated with the travel itinerary. Risk score facility 308 may update the risk score as a departure time associated with the travel itinerary approaches because the accuracy in weather prediction may improve. A user traveling with the household animal may use the risk score to assess whether to initially reserve a particular travel itinerary or whether to reschedule to another time. For example, a risk score determined four months prior to departure may be based on historical weather data for a destination indicates a reasonably low likelihood (e.g., 50% chance) that the household animal will be unlikely to travel according to the travel itinerary. As the departure time approaches, this level of risk may change as weather predicted for the destination is determined such that the risk score may decrease, for example, to a lower likelihood (e.g., 30%) five days prior to departure. Those skilled in the art will appreciate how to adapt this description for determining a qualitative score rather than a quantitative score.

Another factor that may impact the ability of the household animal's ability to travel is whether a set of conditions associated with the household animal travelling according to a particular travel itinerary can be met with a sufficient amount of time prior to departure. Some destinations may have requirements that may be difficult to comply with in a short period of time because of the nature of documents that need to be obtained and delays in a certification process of the documentation. Data indicating an amount of time it takes for other household animals to meet these requirements may infer an amount of risk associated with traveling to a particular destination and/or way-point. Risk score facility 308 may determine a risk score that indicates a likelihood that a set of conditions may not be met for the household animal prior to a departure time associated with a travel itinerary. Risk score facility 308 may determine the risk score based on historical data indicating the ability of other household animals to meet a set of conditions associated with traveling to the destination within a period of time. As an example, Hawaii regulations require a blood test be submitted 120 days before arrival for any household animals traveling to Hawaii. Historic data could show, for example, that it takes most users at least 45 days to collect the blood sample and supply it (or the results of a test) to be provided to Hawaii. This historic data may be used to determine a qualitative risk score for a user who plans to travel to Hawaii, where the risk score may be “high” if the user has less than 165 days before departure, as the historic data may indicate that it is unlikely that there is sufficient time for the user to obtain results of the necessary blood test. In contrast, a “low” risk score may be determined if there are more than 165 days prior to departure because the user may have sufficient time to obtain results from the blood test. Those skilled in the art will appreciate how to adapt this description for determining a quantitative score rather than qualitative.

In some embodiments, travel arrangement system 300 may generate a boarding pass for the household animal. The boarding pass may include a photograph of the face and/or body of the household animal and/or other information specific to the animal, such as an identifier for a microchip implant or other scannable device of the animal. The boarding pass may also include other information specific to the travel itinerary, such as a boarding confirmation code and whether the household animal is traveling in the cabin or cargo area of the transportation vehicle. A user may bring the boarding pass to check-in the household animal for travel. A vendor associated with the travel itinerary may use the boarding pass to validate whether the household animal is eligible to board a transportation vehicle associated with the travel itinerary.

For example, a scannable identification device (e.g., microchip, RFID device) may act as identification of the household animal and/or verification that the household animal has complied with any necessary conditions prior to travel. In this manner, the scannable identification device may act as a boarding pass for the household animal. The scannable identification device may be embedded in the household animal. The scannable identification device may act as a tracking device for tracking the location of the household animal. The scannable identification device may also in some cases act as a monitoring device by detecting the animal's health and/or stress. This information may be used to determine whether the household animal experiences any changes in health or stress, particularly while on board in a cargo area of a transportation vehicle.

Additional methods for administering travel arrangements for a household animal associated with a user are described below. It should be appreciated that travel arrangement system 300 and/or the household animal transport clearinghouse platform may be configured to perform any of these methods.

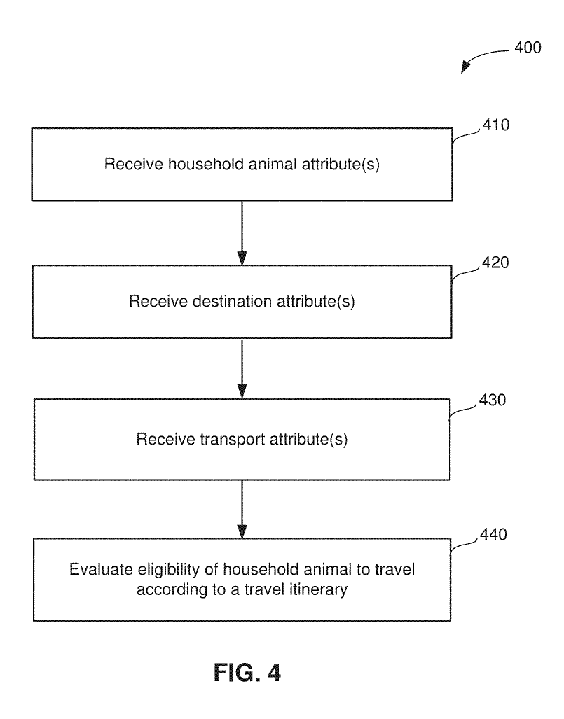

FIG. 4 illustrates an example process 400 that may be implemented in some embodiments to administer travel arrangements for a household animal associated with a user using a travel arrangement system, such as system 300 shown in FIG. 3, and/or the household animal transport clearing house platform discussed in connection with FIG. 1. The process 400 may, in some embodiments, be implemented by an eligibility facility, like eligibility facility 306 of FIG. 3.

The process 400 begins in block 410, in which the eligibility facility receives one or more attributes of the household animal. One household animal attribute that the facility may receive is whether the household animal will be traveling as a pet or with a status as a service animal. Other attributes of the household animal that may be input include information such as a species and breed of the animal, size of the animal, veterinary health records for the animal, or other information described herein. Such information may, in some embodiments, be retrieved by the eligibility facility from a profile maintained by the facility for a user and the user's animal. In other embodiments, the information may be input by a user via a user interface.

In block 420, the eligibility facility receives one or more attributes of a destination to which the user and/or the household animal will travel. The eligibility facility may receive this information in any suitable manner. In some embodiments, a user may input information identifying a destination, and in some cases, travel dates, while in other embodiments a user may input information identifying a travel itinerary and, following retrieval of the travel itinerary, the facility may determine the destination from the itinerary. After identifying one or more destinations, the eligibility facility may determine attributes of the destinations, including regulations in place at a destination (e.g., government legislation or administrative rules, private policies), weather at a destination, or other attributes. The facility may retrieve this information from one or more data stores based on an identity of the destination.

In block 430, the eligibility facility receives one or more attributes for a transport to be used for some or all of the travel by the household animal to the destination. In some embodiments, both the user and the household animal may use the same transport. In other embodiments, the household animal may travel on a transport separate from the user, or it may be the case that the user may not travel (such that the animal may travel without a corresponding passenger). The eligibility facility may receive this information in any suitable manner. In some embodiments, a user may input information identifying a transport, while in other embodiments a user may input information identifying a travel itinerary and, following retrieval of the travel itinerary, the facility may determine the transport from the itinerary. For travel itineraries that include multiple transports, such as different airlines that may be booked for different legs of an itinerary, information on multiple transports that may be determined. After identifying one or more transports, the eligibility facility may determine attributes of the transports, including policies of the transports, types of vehicles (e.g., make and model of vehicle) to be used by the transport during the travel itinerary, and whether there is any availability for animals on a vehicle to be used by the transport during the travel itinerary. The facility may retrieve this information from one or more data stores based on an identity of the transport. For example, once the facility determines a type of a vehicle to be used in the traveling, the facility may query a data store to determine one or more attributes of the type of the vehicle, such as a size of an area for holding animals, or a size of a door through which a container holding an animal would need to fit to reach the animal holding area.

In block 440, the eligibility facility evaluates the eligibility of the household animal to travel according to a travel itinerary, including whether the household animal is eligible to board a transportation vehicle associated with the transport and whether the household animal is eligible to arrive at the destination.

Evaluating eligibility of the household animal may include determining, based on the attributes of the destination and of the transport, one or more constraints on travel of the animal. This may include evaluating regulations applicable to and/or promulgated by the destination or the transport in light of attributes of the household animal to determine constraints that are applicable to the household animal. For example, depending on a species, breed, or size of the household animal, some constraints may be applicable while others are not. As another example, depending on whether the household animal is a service animal, and if so whether the household animal is a service dog or an emotional support animal, some constraints may be applicable while others are not. Further, whether the animal is to travel in-cabin, as excess baggage, or as cargo may impact which constraints are applicable. Accordingly, as a first step, the eligibility facility may determine which of the constraints may be applicable to the household animal, based on the attributes of the household animal, and which are not. This set of constraints that are applicable may determine the set of conditions that the household animal is to satisfy before being eligible to travel according to a travel itinerary.

The eligibility facility may also determine whether the household animal has met, has not met, or cannot meet any of the conditions. The eligibility facility may determine that a condition cannot be met for a variety of reasons. For example, a condition may be associated with a time window, and the facility may determine that the condition cannot be met if the facility determines based on a current time that the window has already passed. As another example, some conditions may be simply binary, such as a condition that there be availability on the transportation vehicle for an animal (e.g., in cases where there is a maximum number of animals permitted on a vehicle, whether the maximum has already been met or whether space is available), or a condition that a particular breed of animal (e.g., pit bull) is prohibited from traveling with a particular transport. Accordingly, a condition that cannot be met may include a condition requiring an action be taken at or within a certain time and the time requirement cannot be met, or that an animal's size or breed or health history violates a requirement. A condition may be determined to be met or not yet met for a variety of other reasons, including when the condition may be linked to submissions of documentation verifying some attribute of the household animal, such as that the animal has recently received an immunization, obtained favorable results from a test (e.g., blood test), and/or was trained to perform as a service dog.

In some embodiments, eligibility facility may determine that one or more of the conditions have not yet been met. In such a case, the system may generate a set of conditions to be met, which the user may treat as tasks to complete for the animal to be eligible for travel. A set of conditions may be a comprehensive travel checklist for a travel itinerary with tasks based on the attributes of the household animal, destination, and transport. In some embodiments, the eligibility facility may determine one or more tasks associated with the household animal meeting one or more of the set of conditions associated with the travel itinerary outputting the one or more tasks. The one or more tasks may be transmitted as a notification to a computing device associated with the user. In some embodiments, the one or more tasks may be transmitted to a computing device associated with a vendor providing that transportation services associated with the travel itinerary.

In some embodiments, the eligibility facility may make repeated determinations of whether a household animal is eligible to travel according to a travel itinerary, such as over time. If a condition has not been met by a departure time associated with the travel itinerary, or it is otherwise determined that a condition cannot be met, then the eligibility facility may determine that the household animal is not allowed to board the transportation vehicle. Eligibility facility may output an indication that the household animal is ineligible to board the transportation vehicle. In some embodiments, a notification indicating the household animal's ineligibility status may be sent to a computing device (e.g., phone, tablet, computer) associated with the user and the user may receive the notification through any suitable communication format (e.g., email, text message, voice message). A notification indicating ineligibility of the household animal to board the transportation vehicle may be transmitted to a device associated with a vendor associated with the transportation vehicle. As an example, an airline company may receive a notification that a household animal has not met all required conditions associated with a particular flight and is not permitted to board the plane of that flight.

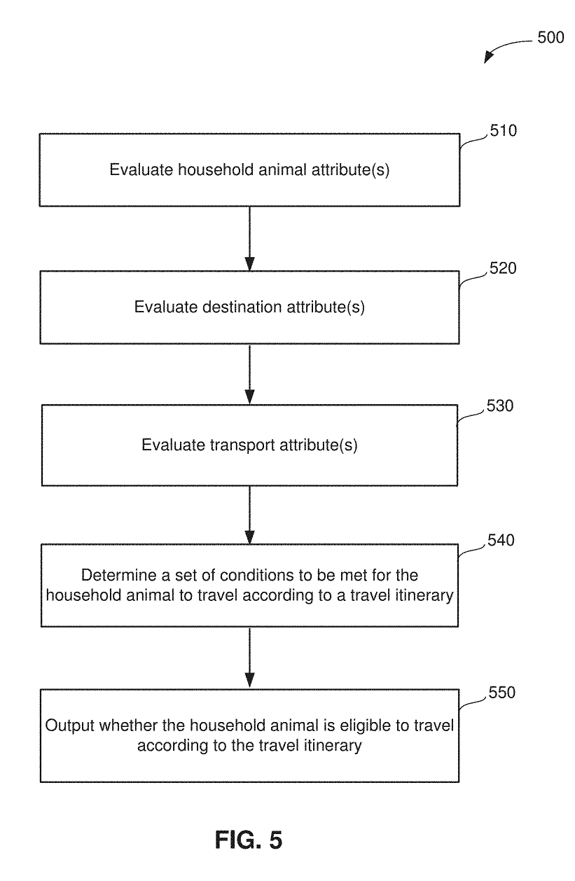

Evaluation of a household animal's eligibility may depend on one or more attributes the household animal, the destination, and the transport used to travel to the destination. FIG. 5 illustrates an example process 500 that may be implemented in some embodiments to evaluate whether a household animal is eligible to travel according to a travel itinerary using a travel arrangement system, such as system 300 shown in FIG. 3, and/or the household animal transport clearing house platform discussed in connection with FIG. 1. The process 500 may, in some embodiments, be implemented by an eligibility facility, like eligibility facility 306 of FIG. 3.

The process 500 begins in block 510, in which the eligibility facility evaluates one or more attributes of the household animal. Evaluation of an attribute of the household animal may include identifying the household animal as either a pet or a service animal of the user. If a user has identified the household animal as a service animal of the user, then evaluation of an attribute of the household animal may include validating the status of the household animal by determining that the user has provided an attestation declaring the status and/or that certified documentation has been provided, such as by the user or a veterinary service provider. Such information may be retrieved by the eligibility facility from a user profile maintained for the user and the household animal. In some embodiments, the information may be input by a user via a user interface.

In block 520, the eligibility facility evaluates one or more destination attributes. Evaluating a destination attribute may include evaluating governmental restrictions of a particular destination associated with the travel itinerary. Evaluation of one or more destination attributes may include evaluation of attributes of the household animal, including breed, age, vaccination status, and health status and how those attributes comply with governmental restrictions associated with the destination. Eligibility facility may retrieve the governmental restrictions from a data store based on the destination information. For example, once the destination is determined, the eligibility facility may query the data store to determine specific governmental restrictions, such as documentation, tests, or other information that is required for the household animal to travel to the destination. If the governmental restrictions indicate that one or more need to be complied with before the household animal is permitted to travel to the destination, then one or more conditions to be met may be determined corresponding to those restrictions that need compliance by the household animal. If the household animal is traveling in cargo or excess baggage area of an airline, evaluating a destination attribute may include determining if the weather at the destination is suitable for the household animal to be exposed to.

In block 530, the eligibility facility evaluates one or more transport attributes. Evaluating a transport attribute may include evaluating transport restrictions of a particular vendor associated with the travel itinerary. Evaluation of one or more transport attributes may include evaluation of attributes of the household animal, including species, breed, size, weight, and status as a pet or as a service animal to determine if those attributes comply with transport restrictions associated with the vendor.

Eligibility facility may retrieve the transport restrictions from a data store based on information specifying the vendor of the transportation services. For example, a booking confirmation may be used as an identifier for the vendor, and the identifier may be used to query a data store to retrieve transport restrictions associated with the vendor.

In some embodiments, a transport attribute may include a characteristic of the type of transportation vehicle associated with the travel itinerary. The type of transportation vehicle may determine whether the household animal may be allowed to travel in a cabin area or a cargo area of the transportation vehicle. If the household animal is a pet, then eligibility facility may assess whether other attributes of the household animal, including the animal's size, breed, weight, and health, would allow the household animal to travel in the cargo area or the cabin area. For example, smaller household animals may be permitted to travel in the cabin area with the user while larger animals would be required to travel in the cargo area.

In block 540, the eligibility facility determines a set of conditions to be met for the household animal to travel according to a travel itinerary. The household animal may be required to meet the set of conditions to be able to board the transportation vehicle and/or be permitted to travel to the destination. The set of conditions may depend on attributes of the household animal, attributes of the destination and/or attributes of the transport. The set of conditions may include conditions to meet in order to comply with governmental restrictions of the destination and/or transport restrictions. In some embodiments, the set of conditions may be stored in a user profile. The owner of the household animal and/or a vendor associated with the travel itinerary may access the set of conditions in the profile to view which conditions have yet to be met. In this manner, both the owner and the vendor may be able to monitor which tasks are necessary for the household animal to be eligible for travel.

In block 550, the eligibility facility outputs whether the household animal is eligible to travel according to the travel itinerary in response to determining whether the set of conditions for the household animal is met. Eligibility facility may output a notification of the household animal's eligibility to the user and/or transporter associated with the travel itinerary via a user interface. The notification may be an email, text message, voice message, and/or any other suitable notification format.

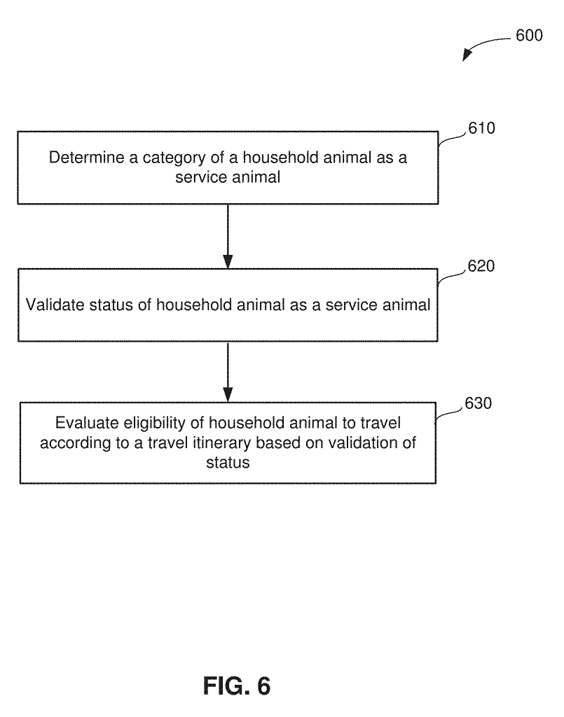

FIG. 6 illustrates an example process 600 that may be implemented in some embodiments to administer travel arrangements for a household animal associated with a user using a travel arrangement system, such as system 300 shown in FIG. 3, and/or the household animal transport clearing house platform discussed in connection with FIG. 1. The process 600 may, in some embodiments, be implemented by an eligibility facility, like eligibility facility 306 of FIG. 3.

The process 600 begins in block 610, in which the eligibility facility determines that a category of the household animal is a service animal, such as service dog, an emotional support animal or another form of support animal. The eligibility facility may receive input from a user, such as the owner of the household animal, indicating that the household animal is a household animal. For example, as a user creates a user profile and enters in information for the household animal into the profile, the user may input that the household animal is a service animal.

In block 620, the eligibility facility validates the status of the household animal as a service animal. Validating the status of the household animal may include, in some embodiments, receiving an attestation from the user declaring that the household animal is a service animal. For example, a user may submit such an attestation in a user profile, which can be stored in the user profile. The attestation may include responses provided by the user to a series of questions, including questions related to the household animal's status as a service animal.

In some embodiments, validating the status of the household animal may additionally or alternatively include receiving documentation verifying that the household animal is a service animal. For example, a user may identify the household animal as a service animal when creating a user profile, but would still be required to provide proper documentation indicating that the household animal is a service animal. Such documentation may vary based on the status of service animal that is claimed. For example, a service animal like a service dog may not be required to submit any documentation or could be demonstrated to be a service dog through a certificate of training of the animal. As another example, for an emotional support animal, the documentation may be for an owner of the animal or a passenger who is to travel with the animal, demonstrating that the person has a medical need that the service animal is to address (e.g., an animal to help a person cope with anxiety).

In block 630, the eligibility facility evaluates eligibility of the household animal to travel according to a travel itinerary based on validation of the animal's status as a service animal. If an attestation by the user indicating that the household animal is a service animal is required, then evaluating eligibility of the household animal may be based on whether such an attestation has been made. If not, a notification (e.g., email, text message) may be transmitted to a user interface associated with the user indicating that an attestation is required for travel. The transporter associated with a travel itinerary may access the user profile to determine whether the attestation has been made in a manner that complies with any restrictions that may be associated with the destination or the transport. The user may submit an attestation at any stage in arranging travel for the household animal. In some embodiments, the user may submit an attestation prior to reserving travel for the household animal on a travel itinerary. In some embodiments, the user may have completed the reservation process and indicated through the reservation that they intend to bring the household animal. After completing the reservation process, the user may be requested to submit an attestation, such as by creating a user profile if the user does not already have one created for the household animal. Prior to departure, if the user has yet to submit an attestation, the user may receive a notification (e.g., email, text message, voice message) indicating that user is required to submit an attestation for the household animal to be allowed to travel.

If documentation indicating that the household animal is a service animal is required, evaluating eligibility of the household animal may be based on validating the status of the household animal as being a service animal. If the proper documentation is provided, then the household animal would be eligible to travel according to the travel itinerary. If no documentation was provided prior to departure, then the household animal would be ineligible to travel according to the travel itinerary.

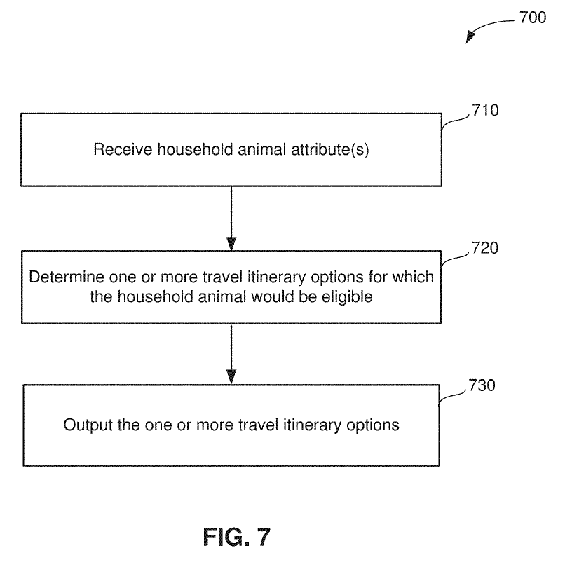

FIG. 7 illustrates an example process 700 that may be implemented in some embodiments to administer travel arrangements for a household animal associated with a user using a travel arrangement system, such as system 300 shown in FIG. 3, and/or the household animal transport clearing house platform discussed in connection with FIG. 1. The process 700 may, in some embodiments, be implemented by an eligibility facility, like eligibility facility 306 of FIG. 3.

The process 700 begins in block 710, in which the eligibility facility receives one or more attributes of a household animal. One attribute of the household animal may include whether the household animal has been identified as a pet or as a service animal of the user. One household animal attribute that the facility may receive is whether the household animal will be traveling as a pet or with a status as a service animal. Other attributes of the household animal that may be input include information such as a species and breed of the animal, size of the animal, veterinary health records for the animal, or other information described herein. Such information may, in some embodiments, be retrieved by the eligibility facility from a profile maintained by the facility for a user and the user's animal. In other embodiments, the information may be input by a user via a user interface.

In block 720, the eligibility facility may determine one or more travel itinerary options for which the household animal would be eligible. The eligibility facility may determine a travel itinerary option based on the one or more attributes of the household animal and whether the household animal would be eligible to travel for one or more combinations of different destinations and different transports. For a combination of a destination and a transport where the household animal would be eligible, a travel itinerary associated with that combination may be identified as a travel itinerary option for the household animal. The eligibility facility may retrieve travel schedules associated with one or more transports based on a destination and/or time of travel. For example, a user may input a destination and/or time of travel and the facility may query one or more data stores, which may include travel schedules associated with different transports, to determine one or more travel itinerary options that allow the user to travel to the destination and/or at the desired time of travel.

In block 730, the one or more travel itinerary options may be presented to the user, such as via a user interface. The user may provide input selecting one of the travel itinerary options identified by eligibly facility as travel arrangements for the household animal. In some embodiments, eligibility facility may determine a set of conditions to be met for the household animal to be able to board a transportation vehicle and/or permitted to travel to a destination associated with the travel itinerary.

In some embodiments, a risk score facility may determine one or more risk scores associated with each of the one or more travel itinerary options where the one or more risk scores indicates a likelihood the household animal will be unable to travel. The risk scores may inform the user which of the travel itinerary options have low and high risk, which may allow the user to select a travel itinerary option having lower risk than the others.

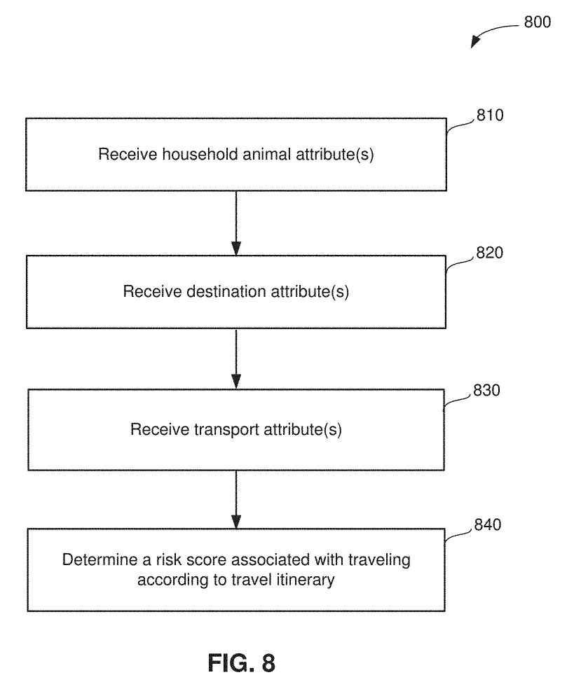

FIG. 8 illustrates an example process 800 that may be implemented in some embodiments to administer travel arrangements for a household animal associated with a user using a travel arrangement system, such as system 300 shown in FIG. 3, and/or the household animal transport clearing house platform discussed in connection with FIG. 1. The process 800 may, in some embodiments, be implemented by a risk score facility, like risk score facility 308 of FIG. 3. The process 800 begins in block 810, in which the risk score facility receives one or more attributes of the household animal. One household animal attribute that the facility may receive is whether the household animal will be traveling as a pet or with a status as a service animal. Other attributes of the household animal that may be input include information such as a species and breed of the animal, size of the animal, veterinary health records for the animal, or other information described herein. Such information may, in some embodiments, be retrieved by the risk score facility from a profile maintained by the facility for a user and the user's animal. In other embodiments, the information may be input by a user via a user interface.

In block 820, the risk score facility receives one or more attributes of a destination for the user and the household animal. The risk score facility may receive this information in any suitable manner. In some embodiments, a user may input information identifying a destination, while in other embodiments a user may input information identifying a travel itinerary and, following retrieval of the travel itinerary, the facility may determine the destination from the itinerary. After identifying one or more destinations, the eligibility facility may determine attributes of the destinations, including regulations in place at a destination (e.g., government legislation or administrative rules, private policies), weather at a destination, or other attributes. The facility may retrieve this information from one or more data stores based on an identity of the destination.

In block 830, the risk score facility receives one or more attributes for a transport to be used for some or all of travel by the household animal to the destination. In some embodiments, a user may input information identifying a transport, while in other embodiments a user may input information identifying a travel itinerary and, following retrieval of the travel itinerary, the facility may determine the transport from the itinerary. For travel itineraries that include multiple transports, such as different airlines that may be booked for different legs of an itinerary, information on multiple transports that may be determined. After identifying one or more transports, the risk score facility may determine attributes of the transports, including policies of the transports, types of vehicles (e.g., make and model of vehicle) to be used by the transport during the travel itinerary, and whether there is any availability for animals on a vehicle to be used by the transport during the travel itinerary. The facility may retrieve this information from one or more data stores based on an identity of the transport. For example, once the facility determines a type of a vehicle to be used in the traveling, the facility may query a data store to determine one or more attributes of the type of the vehicle, such as a size of an area for holding animals, or a size of a door through which a container holding an animal would need to fit to reach the animal holding area.

In block 840, the risk score facility determines one or more one risk scores associated with a travel itinerary for the household animal to travel to the destination. A risk score may indicate a likelihood the household animal will be unable to travel according to the travel itinerary. In some embodiments, the risk score facility may determine a qualitative risk score associated with a particular travel itinerary. The qualitative risk score may indicate for example a “low,” “medium,” or “high” level of risk. In some such embodiments, the qualitative risk score may be evaluated using one or more rules, such as rules that evaluate a number of conditions or a number of tasks necessary to satisfy one or more conditions. With increasing number of conditions/tasks, a higher qualitative risk may be determined, such as by having different thresholds associated with “low,” “medium,” and “high.” In some embodiments, the risk score facility may determine a quantitative risk score, such as a numerical value, probability, percentage or other suitable type of numerical representation associated with the amount of risk associated with a travel itinerary. Such a quantitative score may be determined in a variety of ways, including using a trained model generated and evaluated using a machine learning engine. The machine learning engine may be trained using data on past ability of owners of household animals to perform tasks or otherwise comply with conditions and the ultimate eligibility of the animal to travel according to an itinerary. The model may also be trained based on underlying data for the eligibility determination for the animal, including the set of conditions identified for the household animal to be eligible, attributes of the household animal, attributes of the transport, attributes of the destination, time, weather, or other factors. Once trained, the model may be used to generate a prediction for a particular household animal based on the set of conditions identified for the household animal to be eligible, attributes of the household animal, attributes of the transport, attributes of the destination, time, weather, or other factors. Risk associated with a particular travel itinerary and whether the household animal may be able to travel according to the travel itinerary at a departure time associated with the travel itinerary may depend on one or more factors. In some embodiments, the destination attributes may include the weather at the destination during which the household animal is expected to arrive. In such cases, risk score facility may generate a predication, based on historical weather data, whether the weather will impact the ability of the household animal to travel to the destination. The risk score facility may determine one or more risk scores indicating a likelihood that weather at the at least one location may negatively impact the ability of the household animal to travel according to the travel itinerary. The risk score facility may determine the risk score based on prior weather data corresponding to one or more locations (e.g., destination, a way-point) associated with the travel itinerary. In some embodiments, the risk score facility may implement machine learning techniques to identify patterns and trends in historical weather data for a location and apply those patterns and trends to predict future weather for the location. The risk score facility may modify a risk score associated with a travel itinerary over time, such as a departure time associated with the travel itinerary approaches, because the ability to predict more immediate future weather may improve. For example, a user may make a reservation for a particular travel itinerary that has a departure time four months for the time when the reservation is made. As the departure time approaches, the ability to predict weather for one or more locations associated with the travel itinerary may improve such that the risk score becomes more accurate as the departure time approaches.

In some embodiments, risk score facility may determine a risk score that indicates a likelihood that the set of conditions may not be met for the household animal prior to a departure time associated with the travel itinerary. In such cases, the risk score facility may determine the risk score based on data indicating the ability of other household animals to meet a set of conditions associated with traveling to the destination within a period of time. For example, household animals traveling to Hawaii are required to submit results of a blood test that is required to be tested by a particular lab. Delays in processing of samples at the lab may result in the owners of these household animals not receiving the results of the tests for prolonged period of time. A risk score that a user may not receive results in time for departure may be determined based on historical data associated with when others have been able to comply with submitting these test results.

The risk score determined by the risk score facility and data associated with the household animal may be used to further train a model, which may be used to determine new risk scores, such as for other users. The data may include any attributes concerning the household animal, the transport, and/or the destination, and/or related to the ability of a user associated with the household animal to perform tasks, the ability of the user to comply with particular conditions, how much time it took the user to perform specific tasks or comply with specific conditions, whether eligibility of the household animal to travel according to the travel itinerary has been met, or other information related to eligibility of the animal to travel. The data may be inputted as parameters into a machine learning engine, which may evaluate the performance of a current version of the trained model, and in some embodiments, generate an updated version of the trained model that accounts for the data. In this manner, the data associated with the household animal and user can be used to modify the trained model over time and/or across different users. This feedback loop of inputting attributes related to eligibility as well as conditions related to eligibility and the ultimate determination on eligibility may allow the trained model to improve its accuracy in predicting risk and generating risk scores over time and/or account for changes in ability of users to meet particular conditions or complete specific tasks, such as whether a specific lab performing veterinary testing suddenly experiences delays in providing test results. For example, the risk score facility may determine a relatively low risk score associated with traveling according to a travel itinerary. If the user encounters delays in meeting one of the conditions, such as obtaining required blood test results, that prevent the household animal from being eligible to travel, then the trained model may be updated based on this data to improve future determination of risk scores, particularly for those associated with travel itineraries that have the same or similar condition that the user was unable to meet.

Techniques operating according to the principles described herein may be implemented in any suitable manner. Included in the discussion above are a series of flow charts showing the steps and acts of various processes that administer travel arrangements for a household animal. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

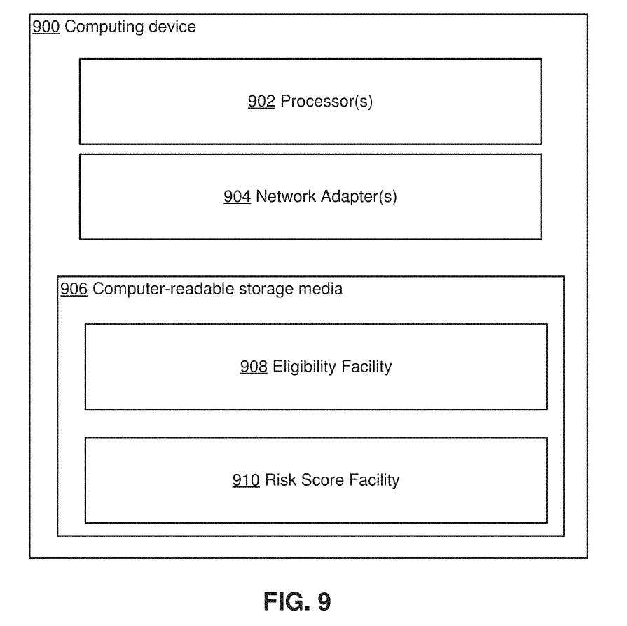

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 906 of FIG. 9 described below (i.e., as a portion of a computing device 900) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 3, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

FIG. 9 illustrates one exemplary implementation of a computing device in the form of a computing device 900 that may be used in a system implementing techniques described herein, although others are possible. Computing device 900 may operate a travel arrangement system and control the functionality of the travel arrangement system. It should be appreciated that FIG. 9 is intended neither to be a depiction of necessary components for a computing device to operate in accordance with the principles described herein, nor a comprehensive depiction.

Computing device 900 may comprise at least one processor 902, a network adapter 904, and computer-readable storage media 906. Computing device 900 may be, for example, a desktop or laptop personal computer, a personal digital assistant (PDA), a smart mobile phone, a server, or any other suitable computing device. Network adapter 904 may be any suitable hardware and/or software to enable the computing device 900 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 906 may be adapted to store data to be processed and/or instructions to be executed by processor 902. Processor 902 enables processing of data and execution of instructions. The data and instructions may be stored on the computer-readable storage media 906 and may, for example, enable communication between components of the computing device 900.

The data and instructions stored on computer-readable storage media 906 may comprise computer-executable instructions implementing techniques which operate according to the principles described herein. In the example of FIG. 9, computer-readable storage media 906 stores computer-executable instructions implementing various facilities and storing various information as described above. Computer-readable storage media 906 may store eligibility facility 908, risk score facility 910, each of which may implement techniques described above.

While not illustrated in FIG. 9, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. An apparatus comprising:
at least one processor; and
at least one storage medium having encoded thereon executable instructions that, when executed by the at least one processor, cause the at least one processor to carry out a method for administering travel arrangements for a household animal associated with a user, the method comprising:
receiving information identifying at least one attribute of the household animal, at least one attribute of a destination for the user and the household animal, and at least one attribute for a transport to be used for at least a part of travel by the household animal to the destination, wherein the at least one attribute of the household animal comprises whether the household animal has been identified as a pet or as a service animal of the user;
evaluating whether the household animal is eligible to travel according to a travel itinerary including boarding a transportation vehicle associated with the transport and arriving at the destination, wherein evaluating whether the household animal is eligible to travel according to the travel itinerary comprises:
determining, for the travel itinerary, a set of conditions to be met for the household animal to be able to board the transportation vehicle and/or permitted to travel to the destination, wherein determining the set of conditions comprises evaluating the at least one attribute of the transport, the at least one attribute of the destination, and the at least one attribute of the household animal including whether the household animal has been identified as a pet or as a service animal of the user; and
outputting, in response to determining whether the set of conditions for the household animal is met, whether the household animal is eligible to travel according to the travel itinerary.

2. The apparatus of claim 1, wherein the method further comprises:
in response to determining that the household animal is a service animal, validating information identifying the household animal as a service animal, wherein validating comprises prompting the user to submit documentation demonstrating that the household animal is acting as a service animal; and
wherein evaluating whether the household animal is eligible to travel according to the travel itinerary comprises evaluating whether the household animal is eligible to travel as a service animal, and wherein evaluating whether the household animal is eligible to travel as a service animal comprises confirming that the user has submitted documentation demonstrating that the household animal is acting as a service animal.

3. The apparatus of claim 2, wherein evaluating whether the household animal is eligible to travel as a service animal further comprises validating that the documentation demonstrates that the household animal is acting as a service animal, wherein the validating comprises confirming that the household animal is fulfilling a medical need of a passenger who will travel with the household animal as a service animal.

4. The apparatus of claim 3, wherein validating that the documentation demonstrates that the household animal is acting as a service animal and confirming that the household animal is fulfilling a medical need of a passenger comprises:
providing the documentation to a clinician who did not author the documentation; and
receiving a validation result from the clinician.

5. The apparatus of claim 3, wherein validating that the documentation demonstrates that the household animal is acting as a service animal and confirming that the household animal is fulfilling a medical need of a passenger comprises prompting a clinician who authored at least some of the documentation to confirm that the at least some of the documentation is valid.

6. The apparatus of claim 1, wherein the method further comprises:
in response to determining that the household animal is a service animal, validating information identifying the household animal as a service animal, wherein validating comprises prompting the user to submit attestation declaring that the household animal is acting as a service animal; and
wherein evaluating whether the household animal is eligible to travel according to the travel itinerary comprises evaluating whether the household animal is eligible to travel as a service animal, and wherein evaluating whether the household animal is eligible to travel as a service animal comprises confirming that the user has submitted attestation declaring that the household animal is acting as a service animal.

7. The apparatus of claim 1, wherein the method further comprises:
in response to determining that the household animal is a service animal, validating information identifying the household animal as a service animal, wherein validating comprises prompting the user to answer at least one question related to the household animal's status as a service animal; and
wherein evaluating whether the household animal is eligible to travel according to the travel itinerary comprises evaluating whether the household animal is eligible to travel as a service animal, and wherein evaluating whether the household animal is eligible to travel as a service animal comprises confirming that the user has answered the at least one question.

8. The apparatus of claim 1, wherein the method further comprises:
determining at least one travel itinerary option by retrieving, based on the destination, travel schedules associated with at least one mode of transportation for traveling to the destination; and
repeating the evaluating, using each successive travel itinerary option of the at least one travel itinerary option as the travel itinerary, to determine for each of the at least one travel itinerary option whether the household animal would be eligible to travel according to the travel itinerary option.

9. The apparatus of claim 1, wherein:
receiving information identifying at least one attribute of a destination for the user and the household animal and at least one attribute for a transport to be used for at least a part of travel by the household animal to the destination comprises
receiving from a user information identifying the travel itinerary and the transport; and
querying, based on the information identifying the travel itinerary, a data source associated with the transport to retrieve the travel itinerary; and
evaluating whether the household animal is eligible to travel according to the travel itinerary, including boarding a transportation vehicle associated with the transport and arriving at the destination, comprises comparing one or more attributes of the household animal to information received in response to the querying, wherein the information received in response to the querying comprises one or more of the attributes of the transportation vehicle and/or an identity of the destination.

10. The apparatus of claim 9, wherein comparing one or more attributes of the household animal to the attributes of the transportation vehicle comprises:
determining whether the attributes of the transportation vehicle indicate that there is an available reservation for a household animal on the transportation vehicle; and
determining whether the attributes of the transportation vehicle indicating that dimensions of a space to accommodate an animal on the transportation vehicle will accommodate a size of the household animal as indicated by the at least one attribute of the household animal.

11. The apparatus of claim 9, wherein:
the method further comprises:
in response to receiving, in response to the querying, an identity of the destination, retrieving destination-specific conditions that govern eligibility of household animals traveling to the destination; and
determining, based at least in part on the at least one attribute of the household animal, the at least one attribute of the household animal comprising whether the animal has been identified as a pet or as a service animal, a subset of the destination-specific conditions that are applicable to the household animal for travel to the destination, the subset comprising one or more of the destination-specific conditions; and
evaluating whether the household animal is eligible to travel comprises evaluating whether the household animal satisfies the subset of destination-specific conditions.

12. The apparatus of claim 1, wherein the method further comprises, in response to determining at a time prior to a departure time of the travel itinerary that the set of conditions associated with the travel itinerary are not met:
determining that the household animal is not allowed to board the transportation vehicle associated with the travel itinerary; and
outputting a message to notify the user, prior to the departure time, that the household animal will not be allowed to board the transportation vehicle.

13. The apparatus of claim 1, wherein:
determining whether the household animal is eligible to travel comprises determining whether the set of conditions associated with the travel itinerary cannot be met for the household animal prior to a departure time associated with the travel itinerary; and
the method further comprises, in response to determining that the set of conditions cannot be met prior to the departure time, outputting a message to notify the user, prior to the departure time, that the household animal will not be allowed to board the transportation vehicle.

14. The apparatus of claim 13, wherein determining whether the set of conditions cannot be met prior to a departure time comprises comparing a current time and/or a time between a current time and the departure time to a time specified in at least one of the set of conditions to determine whether sufficient time remains to satisfy the set of conditions.

15. The apparatus of claim 1, wherein the method further comprises:
determining a set of one or more tasks associated with the set of conditions, wherein the set of one or more task will, if performed, satisfy one or more of the set of conditions; and
outputting the set of one or more tasks for presentation to the user.

16. The apparatus of claim 1, wherein the method further comprises:
in response to determining that the set of conditions for the household animal is met, generating a boarding pass for the household animal to travel according to the travel itinerary, wherein generating the boarding pass comprises generating the boarding pass to include identification information for the household animal, the identification information for the household animal comprising a photograph of a face and/or body of the household animal and/or an identifier for an identification device embedded in the household animal;
outputting the boarding pass; and
confirming to the transport that the household animal has demonstrated eligibility to travel on the transportation vehicle for the travel itinerary, wherein confirming comprises transmitting a confirmation message to at least one computing device associated with the transport via one or more computer communication networks, wherein the confirmation message identifies the travel itinerary and the household animal.

17. The apparatus of claim 1, wherein evaluating eligibility of the household animal to travel according to the travel itinerary comprises, prior to a departure time associated with the travel itinerary, evaluating the set of conditions to determine a likelihood that the set of conditions will be satisfied and the household animal will be able to travel according to the travel itinerary.

18. The apparatus of claim 17, wherein evaluating the set of conditions to determine the likelihood comprises:
evaluating the set of conditions using a trained model, the trained model having been trained based on past occurrences of sets of conditions and ability of owners of household animals to satisfy conditions for the household animals to be eligible to travel; and
generating, as a result of the evaluating using the trained model, a quantitative score indicating a likelihood that the set of conditions will be satisfied and the household animal will be able to travel according to the travel itinerary.

19. The apparatus of claim 18, wherein:
the method further comprises obtaining weather information for an origin of the travel itinerary, one or more intermediate destinations for the travel itinerary, and the destination, wherein the weather information comprises historical weather information for the origin, the one or more intermediate destinations, and the destination and/or a weather prediction for weather during the travel itinerary at the origin, the one or more intermediate destinations, and the destination;
evaluating the set of conditions using the trained model comprises evaluating the set of conditions and the weather information using the trained model; and
generating the likelihood comprises generating, as a result of evaluating the set of conditions and the weather information using the trained model, a quantitative score indicating a likelihood the set of conditions, including conditions related to weather, will be satisfied and the household animal will be able to travel according to the travel itinerary.

20. The apparatus of claim 18, wherein the method further comprises:
in response to determining that an outcome that is that the household animal will be eligible to travel according to the travel itinerary or that the set of conditions cannot be met and the household animal will not be eligible to travel according to the travel itinerary, training the trained model based on the set of conditions and the outcome.

21. The apparatus of claim 1, wherein the at least one attribute of the household animal includes one or more attributes selected from the group comprising species, breed, size, weight, age, health status, vaccination status, and training status.

22. The apparatus of claim 1, wherein the at least one attribute of the transport includes one or more attributes selected from the group comprising a mode of transport, type of transportation vehicle, household animal cabin capacity, household animal cargo capacity, travel restrictions based on breed type, travel restrictions based on species, and at least one policy instituted by a transporter that restrict household animal transport.

23. The apparatus of claim 1, wherein the at least one attribute of the destination includes one or more attributes selected from the group comprising a location of the destination, a location of a waypoint, destination government regulations, ambient weather at a destination, and ambient weather at a waypoint.

24. The apparatus of claim 1, wherein;
determining the set of conditions comprises determining, based on the at least one attribute of the household animal that includes a species of the household animal and a size of the household animal, one or more conditions that are applicable to travel by the household animal on the transportation vehicle associated with the transport and travel by the household animal to the destination; and
determining whether the set of conditions for the household animal is met comprises determining whether the household animal satisfies the one or more conditions that are applicable to the at least one attribute of the household animal including species and size.

25. The apparatus of claim 24, wherein:
receiving information identifying at least one attribute for a transport to be used for at least a part of travel by the household animal comprises retrieving, from at least one computing device associated with the transport and based on an identifier for a travel itinerary, a type of a transportation vehicle on which the household animal will travel for at least a part of the travel itinerary;
determining the one or more conditions that are applicable to travel by the household animal comprises determining, based on the type of the transportation vehicle, one or more size limits that are specific to the type of the transportation vehicle and will apply to the household animal and/or a container in which the household animal will travel on the transportation vehicle; and
determining whether the set of conditions for the household animal is met comprises comparing the at least one attribute of the household animal to the one or more size limits.

26. The apparatus of claim 1, wherein:
receiving information identifying at least one attribute of the destination comprises identifying, based on the at least one attribute of the household animal including the species of the household animal, one or more veterinary health requirements of the destination; and
determining whether the set of conditions for the household animal is met comprises comparing a health record of the household animal to the one or more veterinary health requirements of the destination.

27. At least one computer-readable storage medium storing computer-executable instructions that, when executed, perform a method for administering travel arrangements for a household animal, the method comprising:
receiving information identifying at least one attribute of the household animal, at least one attribute of a destination for the household animal, and at least one attribute for a transport to be used for at least a part of travel by the household animal to the destination, wherein the at least one attribute of the household animal comprises whether the household animal has been identified as a pet or as a service animal;
evaluating whether the household animal is eligible to travel according to a travel itinerary including boarding a transportation vehicle associated with the transport and arriving at the destination, wherein evaluating whether the household animal is eligible to travel according to the travel itinerary comprises:
determining, for the travel itinerary, a set of conditions to be met for the household animal to be able to board the transportation vehicle and/or permitted to travel to the destination, wherein determining the set of conditions comprises evaluating the at least one attribute of the transport, the at least one attribute of the destination, and the at least one attribute of the household animal including whether the household animal has been identified as a pet or as a service animal; and
outputting, in response to determining whether the set of conditions for the household animal is met, whether the household animal is eligible to travel according to the travel itinerary.

28. A method for administering travel arrangements for a household animal associated with a user, the method comprising:
receiving information identifying at least one attribute of the household animal, wherein the at least one attribute of the household animal comprises whether the household animal has been identified as a pet or as a service animal of the user;
determining at least one travel itinerary option for which the household animal would be eligible, wherein determining the at least one travel itinerary option comprises:
determining, based at least in part on the at least one attribute of the household animal, whether for each of a plurality of combinations of a destination, from a plurality of destinations, and a transport, from a plurality of transports, whether the household animal would be eligible to travel based on a travel itinerary including the destination and the transport;
in response to determining that the household animal would be eligible to travel based on a travel itinerary including the destination and the transport, identifying the travel itinerary as a travel itinerary option of the at least one travel itinerary option; and
outputting the at least one travel itinerary option for presentation to the user.

29. The method of claim 28, wherein the method further comprises:
receiving, from the user, input indicating selection of a travel itinerary from the at least one travel itinerary option;
determining, for the travel itinerary, a set of conditions to be met for the household animal to be able to board a transportation vehicle and/or permitted to travel to a destination associated with the travel itinerary; and
outputting, in response to determining whether the set of conditions for the household animal is met, whether the household animal is eligible to travel according to the travel itinerary.

30. The method of claim 28, wherein the method further comprises: determining at least one risk score associated with each of the at least one travel itinerary option, wherein the at least one risk score indicates a likelihood the household animal will be unable to travel according to the at least one travel itinerary option.
